(19) United States
(12) Patent Application Publication
(10) Pub. No.: US 2003/0120526 A1
(43) Pub. Date: Jun. 26, 2003

(54) System and method for managing booking and expensing of travel products and services

(76) Inventors: Jonathan Altman, Bethesda, MD (US); Michael Fredericks, Fairfax, VA (US); Andrew Csontos, Alexandria, VA (US); Michael Lore, Vienna, VA (US); John Love, Falls Church, VA (US); Bret Harris, Dummerston, VT (US); John Lueker, Springfield, VA (US); Valery Gorodnichev, Alexandria, VA (US); Jeannine Armstrong, Sea Cliff, NY (US); Joseph Dunnick, Alexandria, VA (US); Bruce Elliott, Darien, CT (US); Gary Mendel, Arlington, VA (US); Thomas Jones, Vienna, VA (US); Thomas DePasquale, Arlington, VA (US)

Correspondence Address: Supervisor, Patent Prosecution Services, PIPER RUDNICK LLP, 1200 Nineteenth Street, N.W., Washington, DC, 20036-2412, US

(21) Appl. No.: 10/270,672

(22) Filed: Oct. 16, 2002

Related U.S. Application Data
(60) Provisional application No. 60/329,281, filed on Oct. 16, 2001.

(51) Int. Cl. G06F 17/60

(52) U.S. Cl. 705/5

(57) ABSTRACT

A system and method for booking and expensing travel products and services utilizing multiple data sources and presenting information pulled from the multiple data sources in one user-friendly format. The following features are included: graphical city selection; policy enforcement; request and approval queues; in-browser agent support; request prioritization; email confirmation and integration; data incorporation into expense reports; and expense report audits. For example, an employee books a ticket, has the booking approved by a manager if needed, receives email confirmation and integrates the booking information into the employee's calendar. The employee also submits, for example, the booking information into an expense report, which can be audited by an employer.

This application claims priority from U.S. Provisional Application Serial No. 60/329,281, filed Oct. 16, 2001. The entirety of that provisional application is incorporated herein by reference.

### BACKGROUND OF THE INVENTION

1. Field of the Invention

The present invention relates generally to an online system and method for managing work flow, and specifically to an online system and method for managing the booking and expensing of travel products and services.

2. Background of the Technology

The travel and entertainment sector has undergone extreme changes in the past century. The advancement of online services has made it easier and more time and cost effective for travelers to make travel arrangements themselves, rather than relying on the services of travel agents, etc. Thus, travelers can search the Internet for available travel products and services, such as airline tickets, hotel rooms, and rental cars.

Although these recent advances have improved the booking process, there remains a need for the booking of travel products and services to be easier and more effective. For example, users need to be able to search using maps instead of only text. In addition, users need to be able to search both carrier and Internet direct fares.

There also remains a need for employers (or other entities that pay travel costs) to effectively manage the booking of travel products and services by their employees who travel. For example, per diem maximums and other travel policies need to be enforced by governments and companies.

Users also often need to talk to travel agents while they are using an online booking system. Automatic email confirmation that can be incorporated into a user's computer system or handheld device is also needed.

Furthermore, the advent of online services has not made the submission of expense reports or their auditing and processing easier.

In view of the foregoing, an improved system and method for managing the booking and expensing of travel products and services is needed.

### SUMMARY OF THE INVENTION

The present invention meets the above-identified needs by providing a system and method for booking and expensing travel products and services.

In one embodiment, the present invention provides a system and method for managing booking of travel products and services by a traveler, comprising: receiving request criteria from the traveler; retrieving at least one option that relates to the request criteria by searching multiple data sources at the same time, the multiple data sources comprising: a global distribution system data source, a public Web site, a travel aggregation public Web site, and a data source privately connected to a vendor; displaying the at least one option to the traveler in a common interface regardless of the data source; receiving at least one selection for booking from the at least one option; directing the user to one of the multiple data sources for booking of the at least one selection; and storing booking information for the at least one selection in a record with a common interface regardless of the data source.

In another embodiment, the present invention provides a system and method for managing booking of travel products and services, comprising: receiving request criteria; retrieving at least one option that relates to the request criteria; presenting the at least one option and information on whether the at least one option is an in-policy option, compliant with a policy entered by a managing entity; receiving at least one selection from the at least one option; and, if the at least one selection is an in-policy option, booking the selection.

In an additional embodiment, the present invention provides a system and method for auditing expensing of products and services, further comprising: searching an expense report for information triggering an audit, wherein the information comprises at least one selected from a group consisting of: information regarding expenses outside defined statistical norms, information regarding expense reports not requiring approval when submitted by an individual that typically submits expense reports requiring approval, information regarding expenses for an individual exceeding a defined dollar amount, and information regarding expense reports older than a defined amount of time; and combining the information triggering an audit in an audit report.

In a further embodiment, the present invention provides a system and method for managing booking of travel products and services, comprising: receiving request criteria, wherein the request criteria comprises destination and arrival locations selected by accessing a map; retrieving codes that correspond to the destination and arrival locations; identifying at least one option that relates to the request criteria; and receiving at least one selection from the at least one option.

The present invention is discussed in the context of preferred embodiments. Persons skilled in the relevant arts, however, will realize that the present invention is not limited to these products and services after reading the description herein.

### BRIEF DESCRIPTION OF THE FIGURES

The features and advantages of the present invention will become more apparent from the detailed description set forth below when taken in conjunction with the drawings in which like reference numbers indicate identical or functionally similar elements.

FIG. 1 illustrates the primary components of a representative operating environment for an embodiment of the present invention.

FIG. 2 illustrates the system architecture, in an embodiment of the present invention.

FIGS. 3-4 illustrate the graphical city selection feature, in an embodiment of the present invention.

FIGS. 5 and 7 illustrate a search preference feature, in an embodiment of the present invention.

FIGS. 6 and 8-12 illustrate the policy enforcement feature, in an embodiment of the present invention.

FIGS. 13-14 illustrate the data integration feature, in an embodiment of the present invention.

FIGS. 15 and 16 illustrate the request and approval queue feature, in an embodiment of the present invention.

FIG. 17 illustrates the prioritization feature, in an embodiment of the present invention.

FIGS. 18 and 19 illustrate the email confirmation and integration feature, in an embodiment of the present invention.

FIG. 20 illustrates the expense report data integration feature, in an embodiment of the present invention.

FIGS. 21-25 illustrate the audit feature, in an embodiment of the present invention.

FIG. 26 illustrates an agent support tool that allows an agent to view the user's actions in real time, in accordance with an embodiment of the present invention.

FIG. 27 illustrates a prepopulation option, in accordance with an embodiment of the present invention.

### DESCRIPTION OF THE INVENTION

The present invention solves the above-identified needs by providing a system and method for booking and expensing travel products and services utilizing multiple data sources and presenting information pulled from the multiple data sources in one user-friendly format. The following features are included: graphical city selection; policy enforcement; request and approval queues; in-browser agent support; request prioritization; email confirmation and integration; data incorporation into expense reports; and expense report audits. For example, an employee books a ticket, has the booking approved by a manager if needed, receives email confirmation and integrates the booking information into the employee's calendar. The employee also submits, for example, the booking information into an expense report, which can be audited by an employer.

In one embodiment, the present invention provides a system and method for managing booking of travel products and services, comprising: receiving request criteria; retrieving at least one option that relates to the request criteria by searching multiple data sources; displaying the at least one option; and requesting at least one selection for booking from the at least one option.

The present invention pulls data for air, car, hotel, train, and other travel products and services from one or more data sources, including global distribution system (GDS) sources, public Web sites (e.g., an individual airline's Web site, an individual hotel's Web site), travel aggregation public Web sites (e.g., Web sites that allow the public to search and book hotels, flights, car rentals), private direct connections to vendors, and other sources. Regardless of the data source, the pulled data is displayed in one format in one display (e.g., GDS fares and Internet fares displayed in one list).

All travel information (e.g., air, car, and hotel segments) for that trip is stored in one trip record, regardless of where the trip was originally booked. (E.g., if a traveler buys a plane ticket from a travel aggregation public Web site, a public Web site, a car from a GDS, all of this information will be displayed in one trip record.) The trip record, in one embodiment, can include automatically generated driving directions and maps to hotels. The trip record enables a traveler, manager, or other user to view all information for a trip regardless of the data source. In addition, the user can be emailed this trip record. Furthermore, the travel information in the trip record can be input into a calendaring system or be reported regardless of the data source. The traveler can also be emailed a notification prior to the trip start indicating changes, upgrades, cancellations, and the cancellation policy. In addition, the information captured (e.g., booking source, confirmation codes, contact information) interfaces with multiple other systems, can be viewed by the agent (e.g., while the user is attempting to book a ticket), and enables the agent to provide an enhanced level of service by providing access to the following information: identification information (e.g., name, phone number, email); current travel request (e.g., the plane ticket the user has selected, plane ticket options displayed to the user); current availability; full trip itinerary and record; requests for a trip in progress; past travel history (even when that history has expired from a GDS); the traveler's profile, the traveler's travel policy; and information enabling the agent to finalize booking. The agent can also search for the user's record by restricting the search to only those users who are currently logged into the system. In addition, the traveler's profile is also constantly updated with the multiple data sources.

In one embodiment, all traveler profile data is synchronized to provide both an online travel booking system and a travel agent with correct traveler information. The following functions are performed to ensure data is accurate and consistent in both systems: the profile data is updated by detecting changes between the online booking system's DBMS and the GDS ensuring that any changes made by the agent will be included and displayed to the user; after the profile is saved, the current profile text in the GDS is read, the full profile is generated, and differences found are added to the GDS profile; the profile is read and parsed on a line by line basis by reading a format specification that exactly describes the structure and content of the GDS profile (the structure of the profile is represented by an extensible markup language (XML) document, and the content by a series of regular expressions that define valid strings); and the profile is written using the format specification and a series of output functions to write to the GDS profile.

In another embodiment, the present invention provides a system and method for managing booking of travel products and services, comprising: receiving request criteria; retrieving at least one option that relates to the request criteria by searching multiple data sources; presenting the at least one option and information on whether the at least one option is an in-policy option, compliant with a policy entered by a managing entity; receiving at least one selection from the at least one option; and, if the at least one selection is an in-policy option, booking the selection.

A manager can enter a customized policy for users, including preferred vendors and textual commentary. The present invention indicates to the person booking the ticket whether a given travel policy is a minor violation (e.g., one that can be ticketed but requires manager notification), or a major violation (e.g., one that cannot be ticketed until manager approval is secured). The travel policy can also be based on external data sources, such as hotel per diem rates. A traveler or other user can view the policy during the booking process.

A traveler is told on-screen, prior to making reservations, whether the selection is compliant with company policy. In one embodiment, color coding and icons are used to make this feature user-friendly. Green signifies no approval necessary, yellow signifies no approval necessary but manager notification necessary, and red signifies manager approval necessary. The travel policy is enforced before the selection can be booked. Thus, the green and yellow fares can be ticketed immediately. Red fares, however, are put into a hold queue of reservations (not bookings). The reservation is then moved to a booking queue when the approval occurs. The travel policy is enforced across all data sources. The user (e.g., traveler, manager, traveler's assistant) can view all outstanding trip requests and all outstanding expense reports.

In another embodiment, priority queues are built if a booking request needs to be taken care of by an agent. The priority queues are based on, for example, profile information of the traveler, specific features of the trip, and the type of task that needs to be completed. Priority can be determined in several ways, including when: the traveler is designated as a VIP; the trip is over a designated dollar amount; the trip occurs in the near future, the traveler has priority standing with a vendor (e.g., a frequent flyer), and the fare expires soon. There can be many grades of priority. The priority queue feature can be combined with the policy enforcement queue feature in an embodiment of the present invention.

In an additional embodiment, the travel information can be incorporated into an expense report, regardless of the source of the original data. The information can include vendors, cities, dates, fares/rates, tax, and payment information. Trips that have been voided or designated as personal are not imported.

The present invention also analyzes the travel plan and suggests possible expenses that the traveler may incur. Then, when the expense report is being generated, the user is reminded that the possible expenses may need to be submitted. For example, the present invention asks how the traveler plans to get to and from the airport (e.g., taxi, limo, or parking). In addition, the itinerary is examined for segments where the traveler is renting a car. Where the traveler is not renting a car, it is asked how the traveler plans to move around on these segments. The dates and types of expenses above are stored.

The present invention also examines data to ensure it is valid. This data can be travel-related data, or other data. For example, if an air ticket is entered into the expense system, and that ticket has been voided, the system will flag the expense. If any part of a travel itinerary is booked as personal, the system will flag the expense as being personal. If a ticket is entered, but was refunded, the system will flag the expense. The expense can be flagged if the credit from the refund is missing, and not flagged if the credit is also being submitted. If a ticket is entered into the expense system, and the ticket was not reserved through the travel system, the expense will be flagged.

Expenses can be flagged in several ways. The user can be blocked from submitting an expense report with the flagged expense, the expense report can require approval, the manager can be notified via email, or reports listing flagged expenses can be generated. Reports can also be generated to show which trips have been booked, but not submitted in the expense system.

Expense reports that pass policy are paid without requiring approval and reports that fail policy require approval before payment. In addition, if a trip was a red fare (requiring manager approval), if the trip also violates expense policy, it can be marked as not requiring approval because it was already approved before the ticket was booked.

The system can also import receipt information. Upon expense report submission, the system automatically calculates what receipts are necessary based on the information that is already in the system (e.g., credit card info, trusted receipts directly from vendors). The system can then advise the user as to which receipts are still needed.

In a further embodiment, the present invention provides a system and method for managing booking of travel products and services, comprising: receiving request criteria, wherein the request criteria comprises destination and arrival locations selected by accessing a map; retrieving codes that correspond to the destination and arrival locations; identifying at least one option that relates to the request criteria; and receiving at least one selection from the at least one option.

The present invention is described in terms of multiple embodiments. This is for convenience only and is not intended to limit the application of the present invention. After reading the following description, it will be apparent to one skilled in the relevant art(s) how to implement the following invention in alternative embodiments.

System Overview

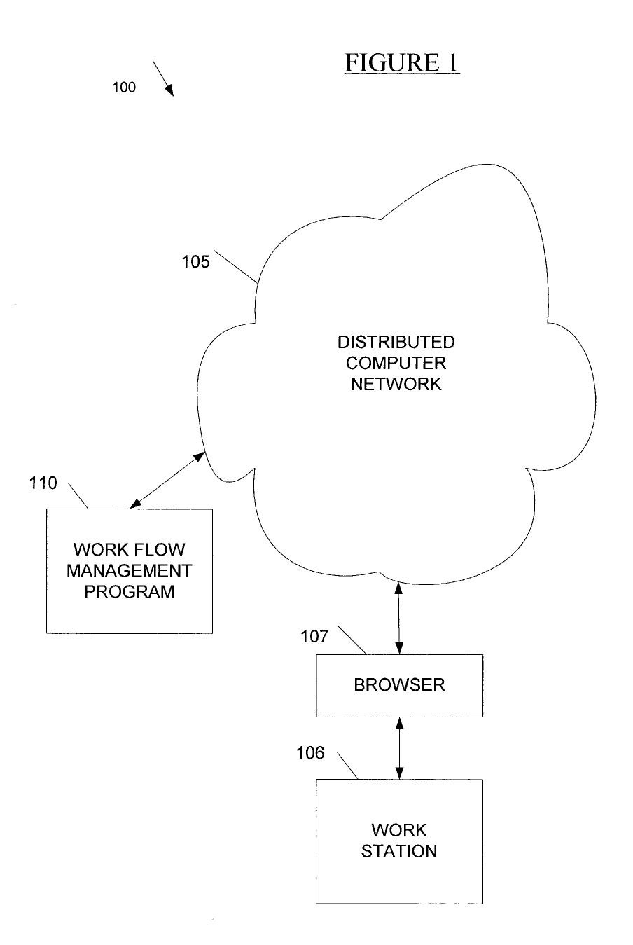

FIG. 1 illustrates the primary components of a representative operating environment for an embodiment of the present invention. An on-line environment 100 comprises: a distributed computer network 105; at least one workstation 106; at least one browser 107; and a workflow management program 110.

A distributed computer network 105 is a network, such as the global Internet, that facilitates communication between one or more workstations 106, one or more browsers 107 and a workflow management program 110.

One or more workstations 106 accept input from users, and allow users to view output from the reporting application.

One or more browsers 107 include software on the workstation 106 that let a user view, for example, HyperText Markup Language (HTML) documents and access files and software related to those documents.

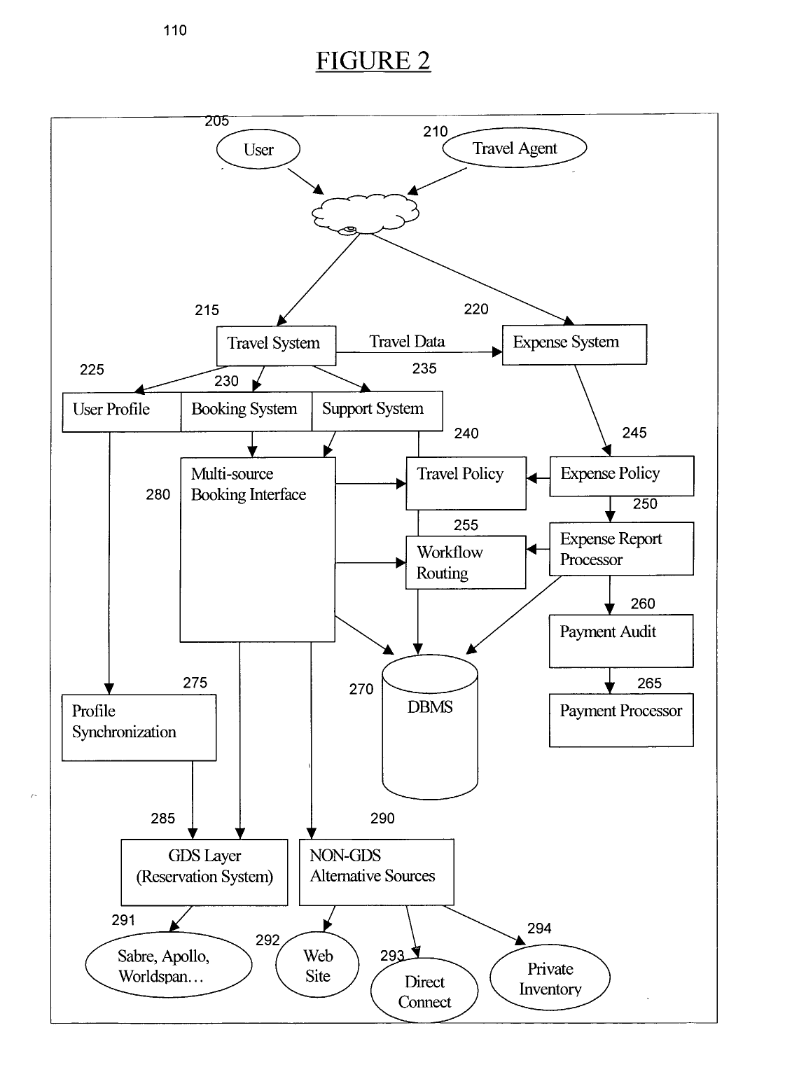

The workflow management program 110 is an application that works on a browser to display information to the user. The details of the workflow management program 110 are set out in FIG. 2.

Workflow Management Program

FIG. 2 contains a diagram illustrating details of the system architecture, in accordance with an embodiment of the present invention.

The system architecture supports corporate travel planning and expense management, and is accessed by a user 205 and/or an agent 210. The travel system 215 provides facilities for management of a user profile 225, online booking system 230, corporate travel policy enforcement 240, and support system assistance 235. The online travel system prepares and submits information into an expense report system for reimbursement. The expense application processes expense reports 250, enforcing corporate expense policy 245 and workflow routing 255, and generates bank transfers using a payment processor 265 to move reimbursement funds form a corporate account into user bank accounts and credit card accounts. These reimbursements are audited by an automated payment audit system 260 as a final failsafe measure to avoid both accidental and intentional overpayment of funds.

The present invention pulls data for air, car, hotel, train, and other travel products and services from one or more data sources using a multi-source booking interface 280, including global distribution system (GDS) sources 291, public Web sites 292, travel aggregation public Web sites 293, private direct connections to vendors 294, and other sources.

The user's profile contains, for example, identity information, travel preferences, affinity programs, payment information, and business information including department, charge codes, and manager information. A copy of the user's profile is maintained in a database management system (DBMS) 270, and within the GDS 285. Upon each profile view in the online system its data is synchronized using a profile synchronization 275 with the contents of the GDS, and user changes in the online system are immediately stored in both the GDS and DBMS.

The booking system combines data from multiple sources (GDS and non-GDS 290) into a single display presented to the user. The GDS abstraction layer facilitates interfacing to multiple different GDS systems and non-GDS source containing air, car, and hotel inventory. The travel policy system is used to evaluate airfare, car and hotel rates, and overall trip costs against the company policy applicable to the traveler. The user's display is coded green, yellow, and red to indicate policy compliance.

Upon completion of the booking process (when the user confirms—“Yes TI want to book this trip”), the newly created PNR will be sent to the workflow system for routing, and to the expense system 220 for incorporation into an expense report. The workflow routing system evaluates the itinerary, and determines if a PNR (reservation in the GDS) is within policy and can proceed to ticketing, or out of policy thus held pre-ticketing pending a manager approval or rejection of the trip. When the manager approves or the system will release the PNR for ticketing or if the manager rejects the trip the PNR will be canceled. When the PNR is released for ticketing, it will be routed to one of several queue's in the GDS based on the type of request, user's VIP status, and other user specific parameters.

Concurrently, the user is presented a break down of items to be sent to the expense reporting system for reimbursement including air, car, hotel expected amounts, and other charges derived from the itinerary such as parking, taxi, and limo charges. The user may add/remove/change these items, and they will then be deposited in the expense reporting application for future submission.

The expense report processor receives expense reports pre-populated with travel expenses from the travel system and incorporates other data that the user enters into the expense report system. When the report is submitted, the items are evaluated against the travelers's reimbursement policy (which typically is based on the policy used at booking time). Items are paid in full, paid partially, or not paid.

Upon final release of the expense report for payment the system generates electronic transfers (ACH files) to transfer funds form corporate accounts to personal accounts, and credit card accounts. These transfers are subjected to a final audit designed to detect changes in reimbursement patterns that may indicate an accidental or intentional overpayment. Once any audit alerts are cleared, the transfer is ready to be sent.

Description of User Workflow through the System

The user logs into the system. The user optionally opens his/her profile, which is synchronized with the GDS upon view, and saved back to the GDS upon save. The user enters travel dates, times, and locations. The user reviews and selects from presented air, car, and hotel options with corporate policy coded on the display. The options are presented or derived by searching multiple GDS and non GDS sources for air fares, car and hotel rates. The user may then optionally request help from the agent. This can include Voice over IP, or sharing their current travel booking session with an agent. This enables an agent to view the users' current state, and provide advice or assistance. The user then completes the itinerary, and confirms it for booking. The itinerary will either be submitted directly for ticketing if it is within policy, or it will be held until a manager approves or rejects the trip. The user may add additional items to be fed to the expense reporting system. This data plus air, car, and hotel information will be sent to the expense reporting system. Once the user completes the trip, they will review, add final expense items and submit the expense report for payment. The expense reporting system will evaluate the report against corporate expense policy, which may involve sending the expense report to the workflow system for payment approval. If and when released for payment, the expense reporting system will generate funds transfers to reimburse the employee's bank and credit cards. The payments transfers are then audited for changes in reimbursement patterns that may indicate an accidental or intentional overpayment. Once any audit alerts are cleared, the transfer is ready to be sent.

Graphical City Selection

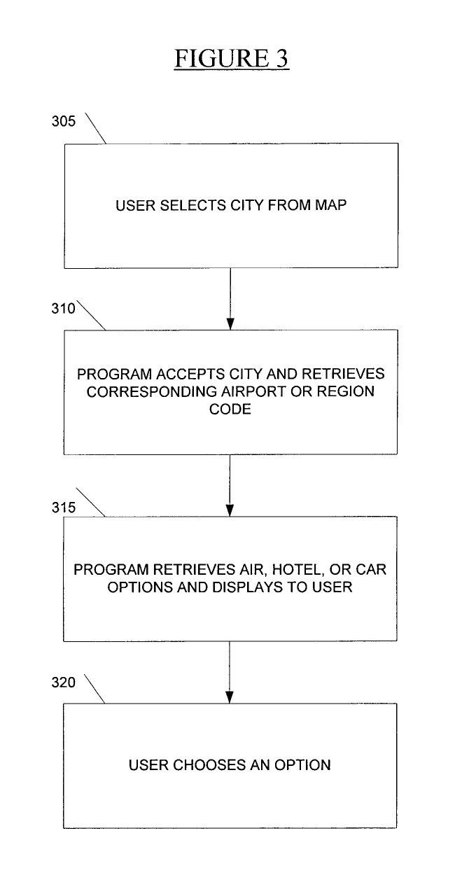

FIG. 3 is a flowchart that illustrates a graphical city selection process 300 in an embodiment of the present invention. In 305, the user selects a city from a map displayed by the browser 107 on the workstation 106. The city is used, for example, as input into the workflow management program 110 for the retrieval of air, hotel, and car availability and rates. In 310, the workflow management program 110 accepts the inputted city and retrieves the corresponding airport or region code to supply to the workflow management program 110. In 315, the workflow management program 110 runs a real-time query using the distributed computer network 105 to retrieve the air, hotel or car availability and rates, and displays the options to the user on the workstation 106. In 320, the user books an option from those displayed on the workstation 106.

In an embodiment, allowing a user to select cities instead of airports makes travel planning easier, eliminates errors, and allows the system to extend the availability search to include all airports in a region.

In an embodiment of the present invention, the system and method are set to default to personal and/or corporate preferred airports. This allows a company to specify that a particular home airport always be included in the search. In a multi-airport city this can force unpopular but cost effective departure airports to be included.

In an additional embodiment of the present invention, the system and method are set to default to personal and corporate preferred airlines, hotels, and cars. This allows, for example, a company to specify that a particular carrier will always be included in the search. This feature is particularly useful for companies that have volume contracts with a particular carrier. When combined with a policy enforcement feature (discussed further below), such as a preferred carrier, a company can enforce strict control over employee travel on non-preferred carriers.

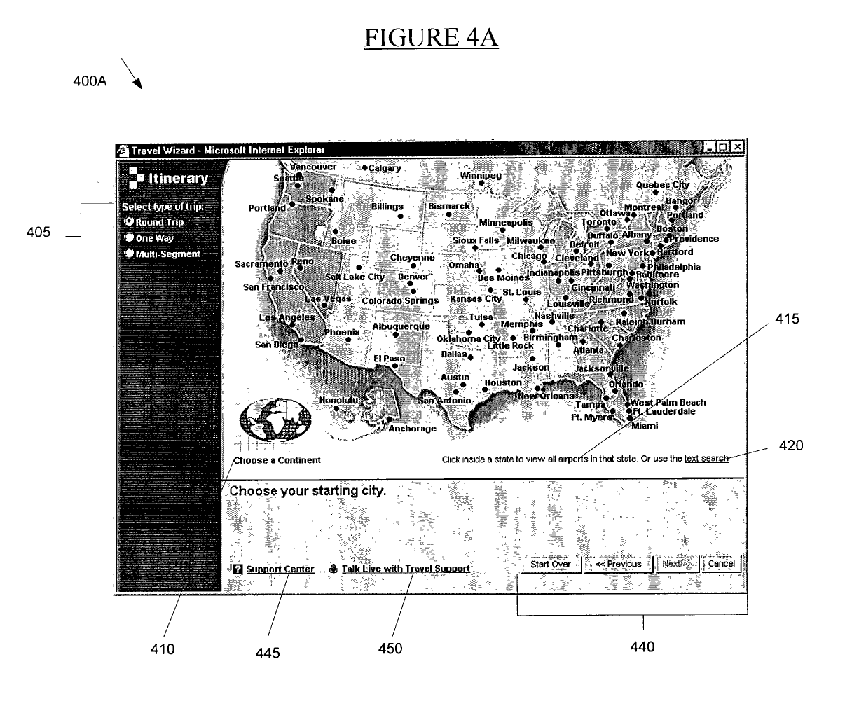

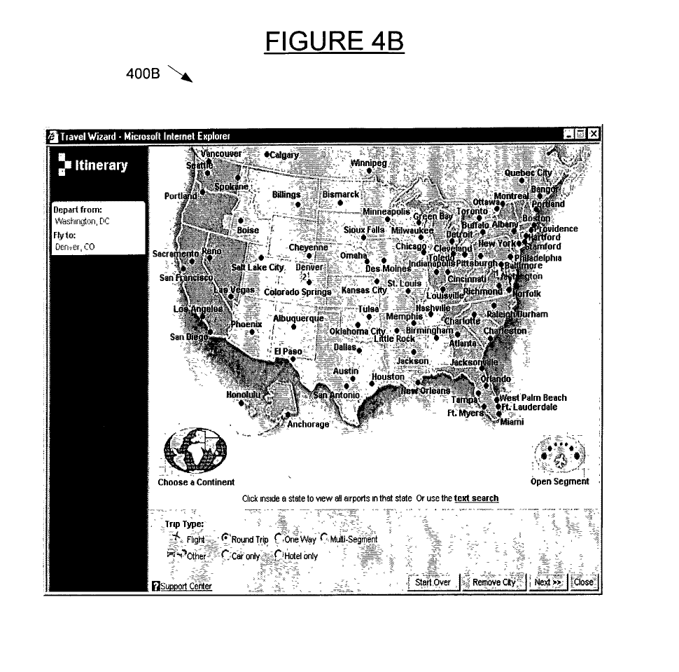

FIG. 4A and 4B are screens 400A and 400B illustrating the graphical city selection feature, as seen by the user during process 300 of FIG. 3 in an embodiment of the present invention. Select Type of Trip feature 405 allows the user to choose between a round trip, one way, or multi-segment itinerary. A Choose a Continent feature 410 allows the user to choose a continent so that the cities on that continent can be viewed. A Click Inside feature 415 allows the user to view all airport in that state. A Text Search feature 420 allows the user to search using text. Navigate feature 440 allows the user to start over, move to the previous screen, move to the next screen, or cancel the search.

Support Center feature 445 allows the user to ask questions of the support center. A Talk Live with Travel Support feature 450 allows the user to talk to a live travel agent. A Support Center feature 445 and a Travel Support feature 450 are part of the in-browser support feature, discussed below. The user can contact the travel agent from within the user's Web browser, or the user can call the travel agent and the travel agent can find the user's record and assist the user or finish the booking.

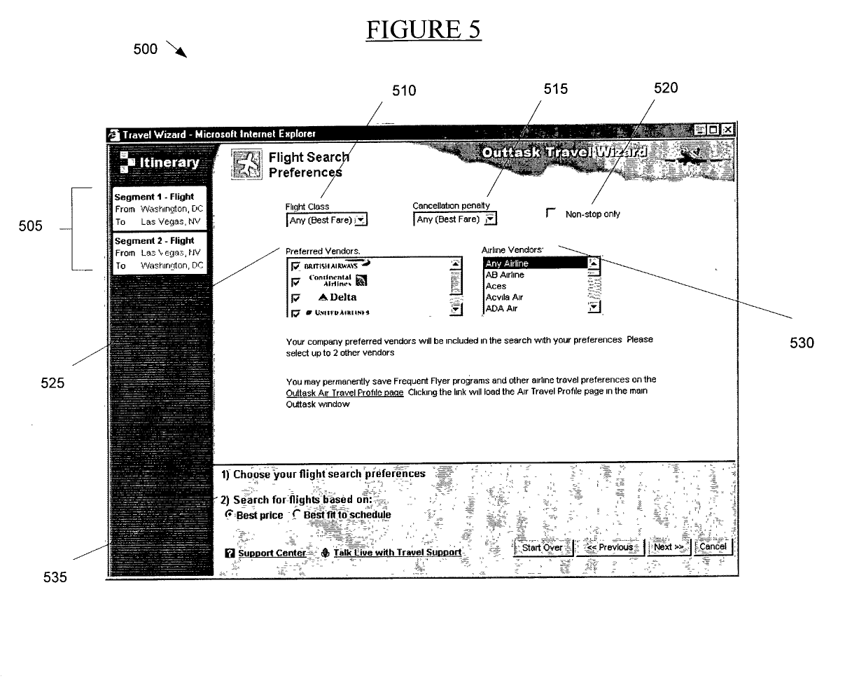

FIG. 5 is a screen 500 illustrating how the user chooses a flight after using the graphical city selection process 300 of FIG. 3 in an embodiment of the present invention. An Itinerary viewing area 505 displays the segments the user has chosen. A Flight Class display area 510 allows the user to choose the flight class (e.g., Any (Best Fare)). A Cancellation Penalty display area 515 allows the user to choose a cancellation penalty (e.g., Any (Best Fare)). A Non-Stop Only check box 520 allows the user to specify whether to search only non-stop flights. Preferred Vendors check boxes 525 display company preferred vendors and allows the user to specify additional preferred vendors. An Airline Vendors display area 530 allows the user to choose airline vendors. Search for Flights Based on Best Price/Best Fit feature 535 allow the user to designate whether the search is run for best prices or best fit to schedule.

Per Diem Policy Enforcement

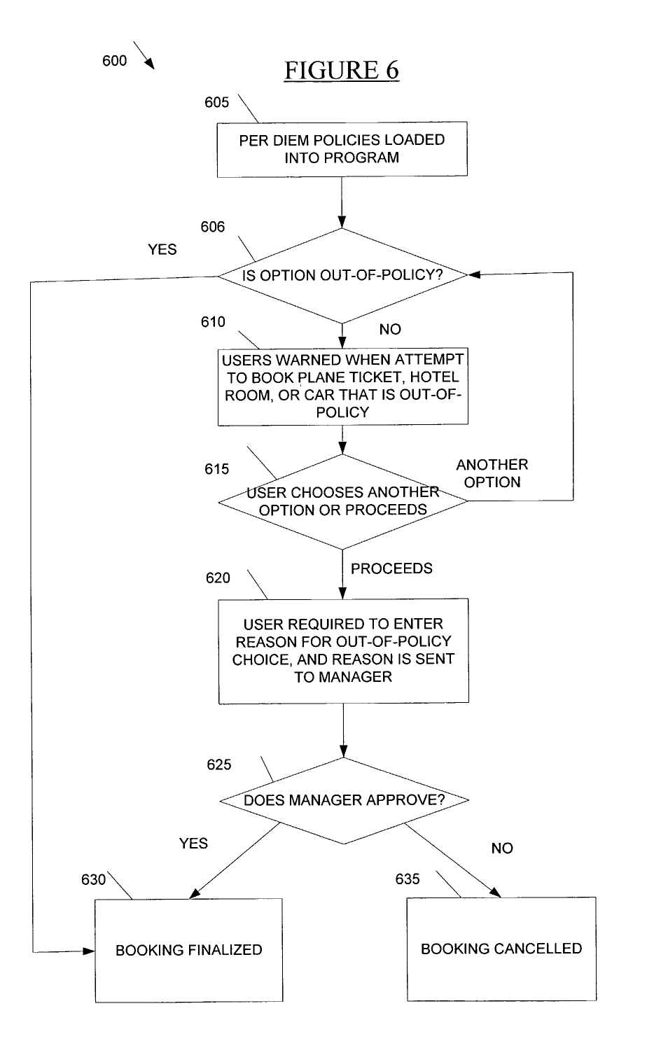

FIG. 6 is a flowchart that illustrates a per diem policy enforcement feature process 600 in an embodiment of the present invention. This process 600 enforces a per diem policy when the user attempts to book (e.g., reserve or buy) an airline ticket, hotel room, or rental car. In such an embodiment, process 600 illustrates a managing entity, such as a manager, providing approval for an individual employee subordinate. Those experienced in the relevant art, however, will realize that other persons or approval mechanisms can be utilized by a company to generate the required approval in accordance with the present invention.

In 605, per-diem policies are loaded into the workflow management program 110. In 606, the workflow management program 110 determines whether an option chosen by the user fits within the per diem policies. If yes, the option fits within the per diem policies, the booking is finalized in 630. If no, the option does not fit within the per diem policies, the user is warned when they attempt to reserve or buy a plane ticket, hotel room, or car in 610. In 615, the user either chooses another option or proceeds with the out-of-policy option. If the user chooses another option, process 600 returns to 606. If the user proceeds, process 600 proceeds to 620, where the user is required to enter a reason for the out-of-policy choice, and the user's manager is informed. In 625, it is determined if the user's manager approves the out-of-policy choice. If yes, the manager does approve, the booking is finalized by the workflow management program 110 in 630. If no, the manager does not approve, the reservation or sale is canceled by the workflow management program 110 in 635.

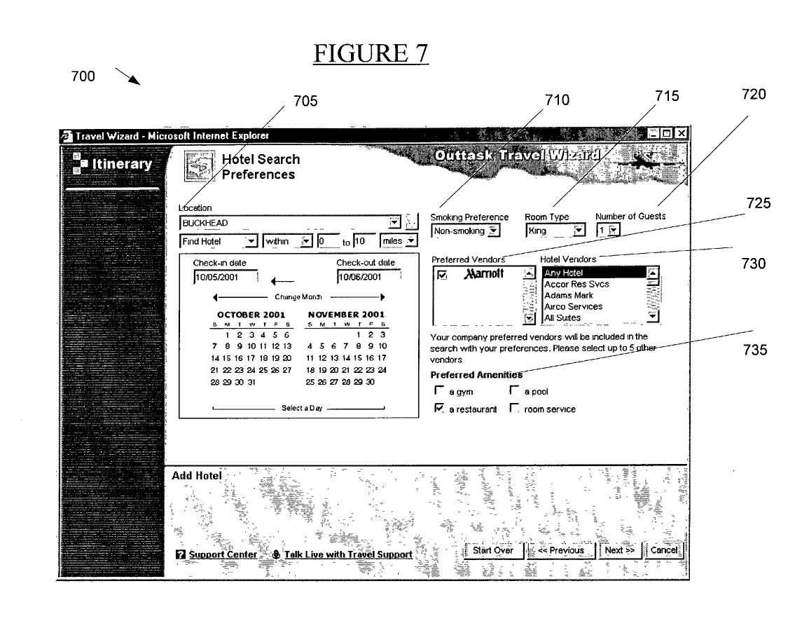

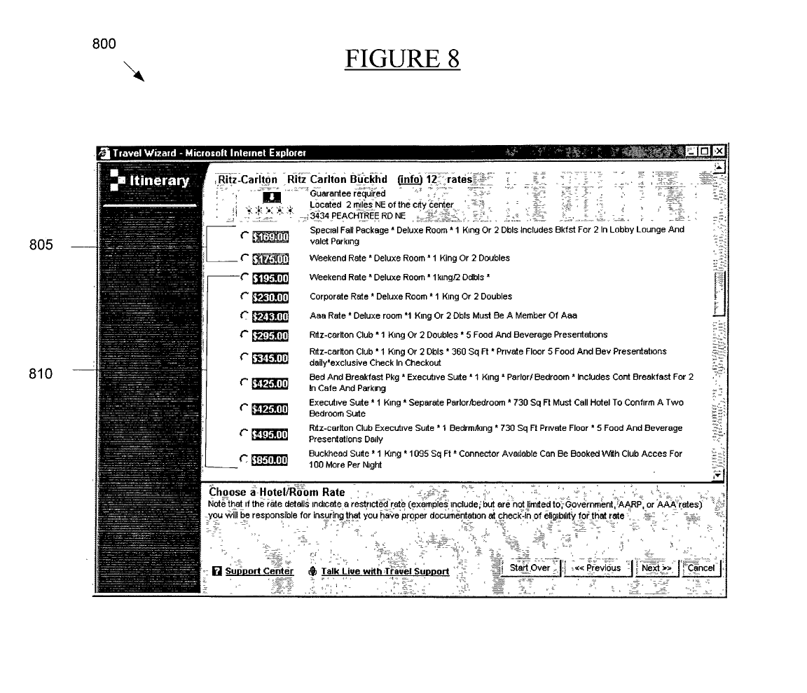

FIG. 7 is a screen 700 illustrating how the user chooses a hotel room with the per diem policy enforcement feature, as seen by the user during process 600 of FIG. 6 in an embodiment of the present invention. Using screen 700, the user can specify hotel search preferences, including a Location display area 705, a Smoking Preference display area 710, a Room Type display area 715, a Number of Guests display area 720, Preferred Vendors check boxes 730 (which already include company preferred vendors), a Hotel Vendors display area 730, and Preferred Amenities check boxes 735.

FIG. 8 is a screen 800 illustrating use of the per diem policy enforcement feature, as seen by the user during process 600 of FIG. 6 in an embodiment of the present invention. The search results based on the hotel search preferences selected on screen 700 are displayed. An In-Policy Search Results display area 805 displays in-policy search results in, for example, one color. In an embodiment, an Out-of-Policy Search Results display area 810 displays the out-of-policy search results in a color different than the in-policy search results. Thus, the user can easily see which search results fit within the per diem policy.

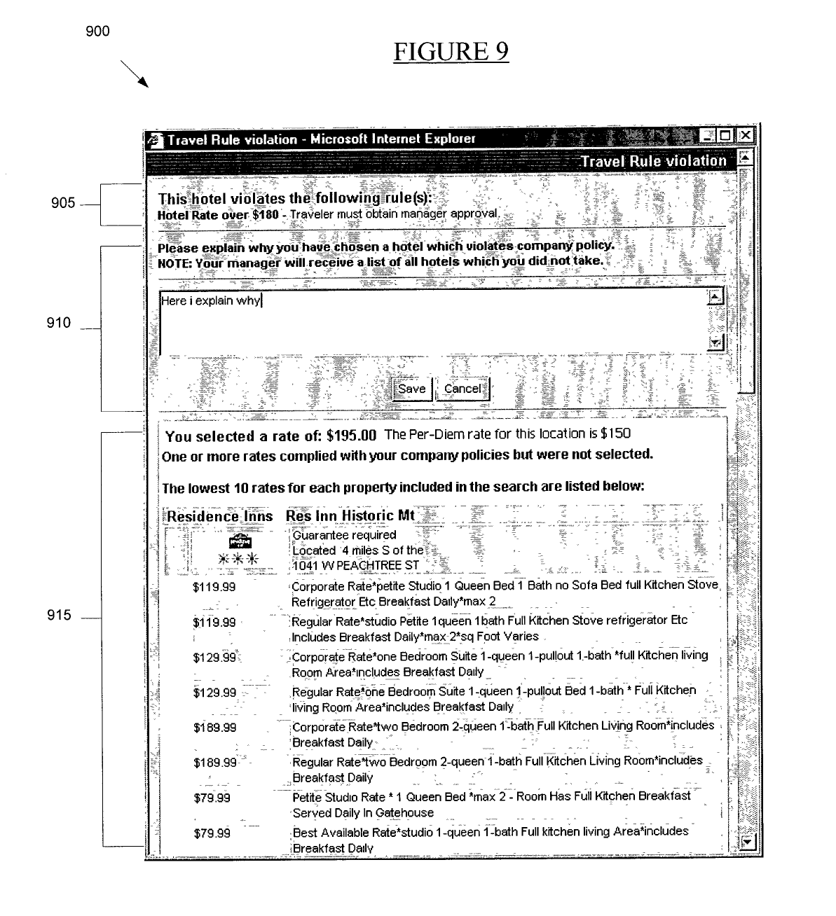

FIG. 9 is a warning and explanation screen 900 for the per diem policy enforcement feature, as seen by the user during process 600 of FIG. 6 in an embodiment of the present invention. If the user selects a search result that is an out-of-policy search result on screen 800, the user will be taken to a warning and explanation screen 900. A Warning display area 905 indicates that the hotel room violates the per diem policy. An Explanation display area 910 allow the user to enter an explanation if the user wishes to obtain approval from a supervisor to book the out-of-policy room. An Other Options display area 915 displays other options so the user can choose an option that is in-policy.

Policy Enforcement

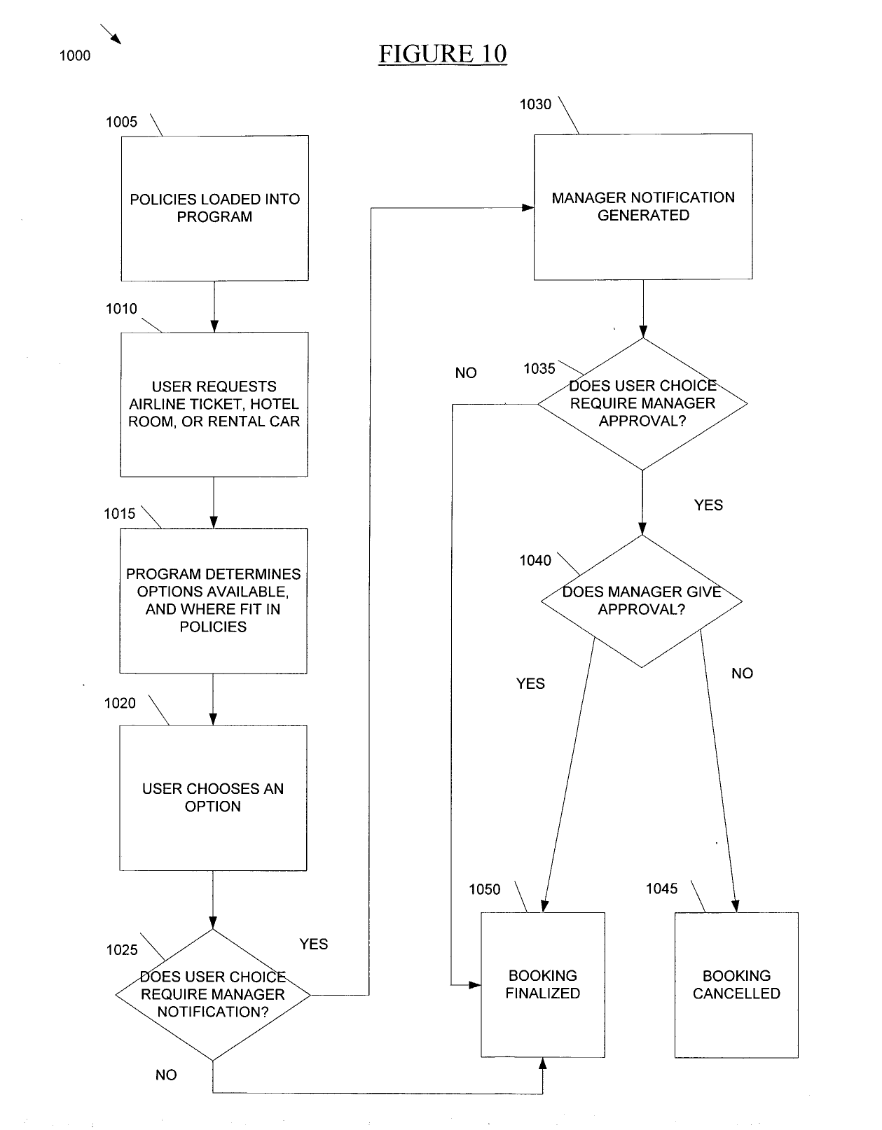

FIG. 10 is a flowchart that illustrates a policy enforcement process 1000 in an embodiment of the present invention. This feature designates and enforces travel policies when the user attempts to book an airline ticket, hotel room, or rental car. Example policies in an embodiment of the present invention include: manager notification and/or approval if rate is $X above the best fare found; manager notification and/or approval if rate exceeds $X maximum allowable by company policy; manager notification and/or approval for a non-preferred carrier or company; manager notification and/or approval for a non-preferred carrier or company, where a preferred carrier or company is within $X of the non-preferred fare; and manager notification and/or approval on a non-preferred carrier between two locations.

The policy enforcement feature is explained in the context of a managing entity, such as a manager, providing approval. Those experienced in the art, however, will realize that any person or approval mechanism can be utilized by a company to generate the required approval.

In addition, the policy enforcement feature is explained in the context of managing booking of travel products or services. The present invention is not limited to this example, and can be used in other work flow management procedures. For example, an employer can use the present invention, including the policy enforcement feature, to manage employee requests for vacation time.

The present invention alerts the employee at the time of the rule infraction (e.g., the hotel room is too expensive) and presents acceptable alternatives to circumvent out-of-policy travel.

In 1005, government, company, or other policies are loaded into the workflow management program 110. In 1010, the user requests an airline ticket, hotel room, or rental car meeting certain criteria. In 1015, the workflow management program 110 determines which options are available, and where the available options fit within the policies. In an embodiment of the present invention, the following codes are used: a green coding indicates the booking is within policy; a yellow coding indicates the booking is allowable but requires manager notification; a red coding indicates the booking is out-of-policy and requires manager approval prior to ticketing.

In 1020, the user chooses an option returned by the workflow management program 110. In 1025, the workflow management program 110 determines whether the user choice requires manager notification. If no manager notification is required, the booking is finalized by the workflow management program 110 in 1050. If manager notification is required, process 1000 proceeds to 1030, where the workflow management program 110 generates a message for the manager that includes the lower cost options that the traveler did not select, and a message from the employee explaining the reason. In an embodiment of the present invention, this information is included in both an email message to the manager and a system log.

In 1035, the workflow management program 110 determines whether the user choice requires manager approval. If no manager approval is required, the booking is finalized in 1050. If manager approval is required, the process 1000 proceeds to 1040, where the workflow management program 110 determines if the user's manager approves the booking. If approval is given, the booking is finalized by the workflow management program 110 in 1050. If no approval is given, the booking is canceled by the workflow management program 110 in 1045.

It should be understood the process 1000 described above, which highlights the functionality and advantages of the policy enforcement feature, is presented for example purposes only. The architecture of the present invention is sufficiently flexible and configurable, such that it may be utilized in ways other than that shown in FIG. 10.

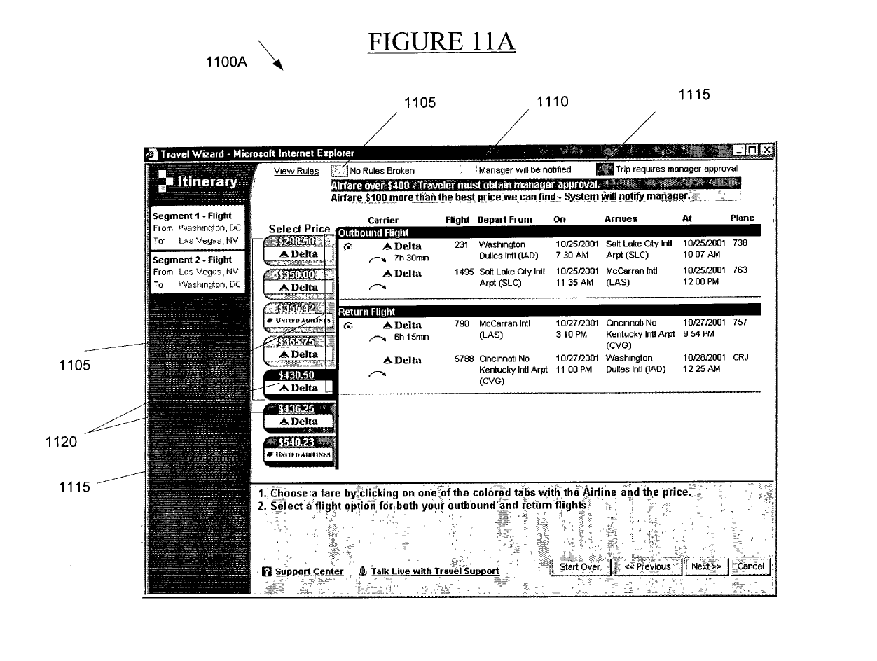

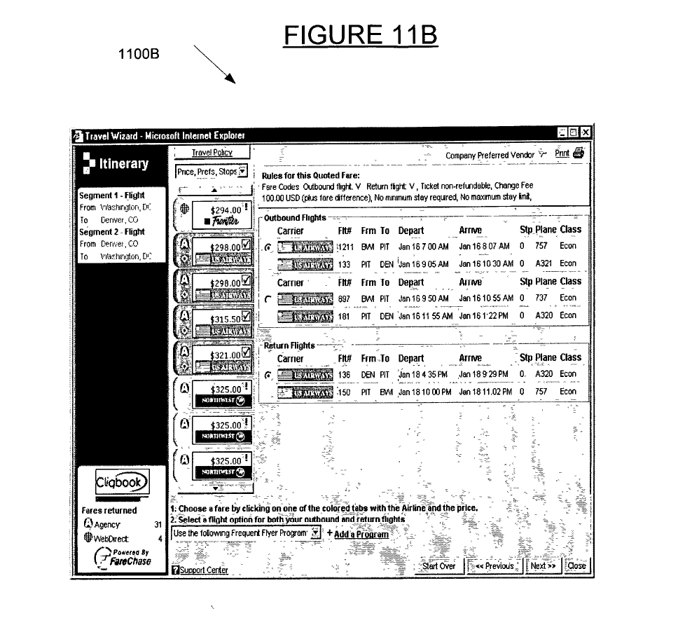

FIGS. 11A and 11B are screen shots 1100A and 1100B illustrating use of the policy enforcement feature, as seen by the user during process 1000 of FIG. 10 in an embodiment of the present invention. The search results based on the flight search preferences selected and shown on screen 300 are displayed. An In-Policy Search Results display 1105 displays search policies that are withing the travel policies in one color. A Manager Notified Search Results display area 1110 displays search results that do not require approval, but which must be reported to a manager. A Require Manager Approval Results display area 1115 displays search results that require manager approval. In an embodiment, manager notified search results, in-policy search results, and require manager approval results are all displayed in different colors so that the user can easily identify the type of search result. Thus, the user (e.g., employer) can easily see which search results fit within their company's travel policy. The user can highlight a Result feature 1120, and see the corresponding Result Details display area 1125.

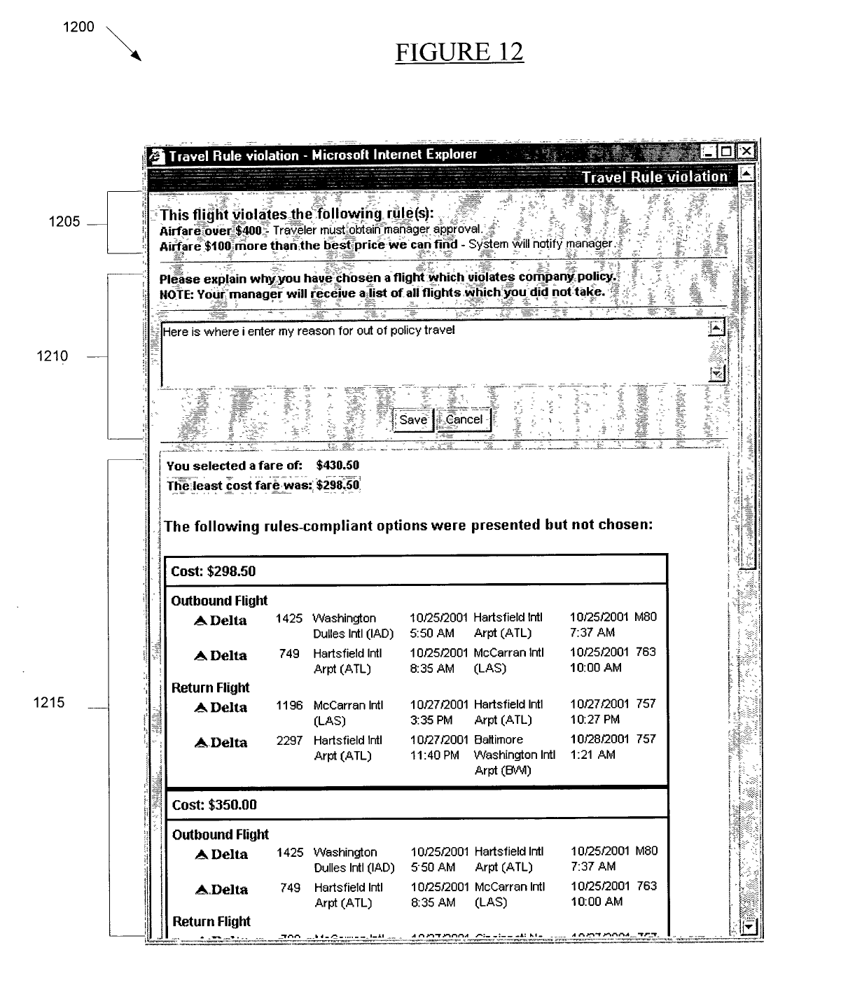

FIG. 12 is a warning and explanation screen 1200 for the travel policy enforcement feature in an embodiment of the present invention. If the user selects a search result that is out-of-policy, listed in a Manager Notified Search Result display area 1110 or a Require Manager Approval Results display area 1115, the user will be taken to a warning and explanation screen 1200. A Warning display area 1205 indicates that the hotel room violates the per diem policy. An Explanation display area 1210 allows the user to enter an explanation if the user wishes to get approval to book the out-of-policy room. An Other Options display area 1215 allows the user to choose an option that is in-policy.

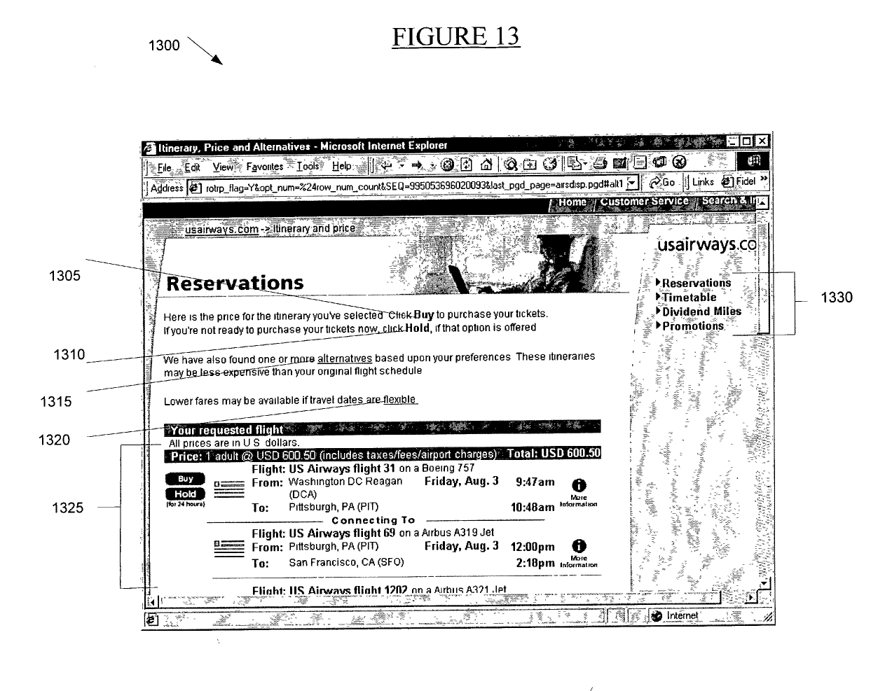

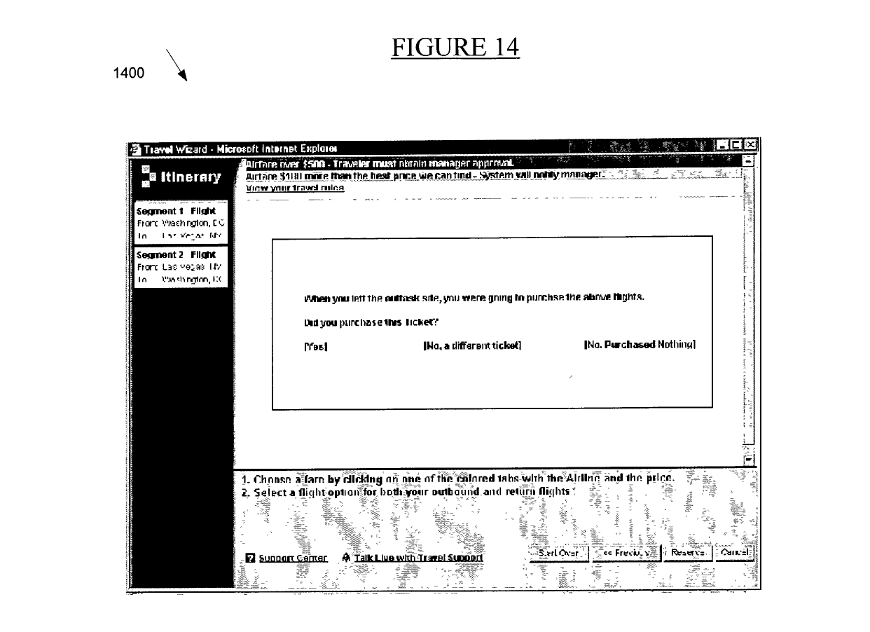

FIGS. 13-14 illustrate the data integration feature, in an embodiment of the present invention. FIG. 13 is a screen shot 1300 illustrating how a user is directed to a specific Web site to book a selection. FIG. 14 is a screen shot 1400 illustrating how the user's purchase information from the Web site of screen shot 1300 is incorporated into the user's travel record.

Request and Approval Queues

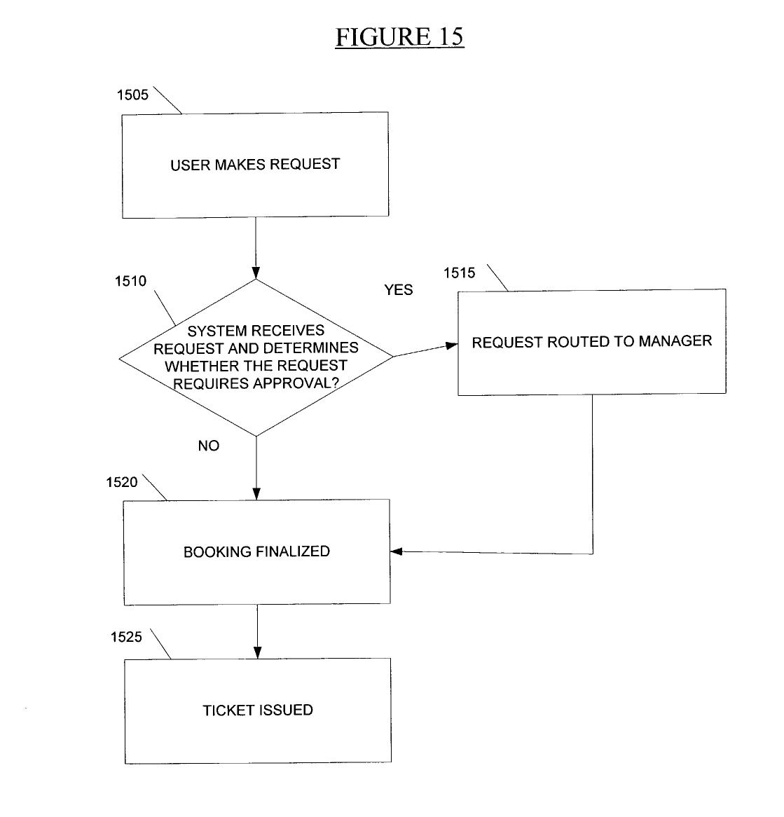

FIG. 15 is a flowchart that illustrates the request and approval queue feature process 1500 in an embodiment of the present invention. This feature is designed to unify user requests across a heterogeneous environment. The user can view a request queue, which tracks requests made by the user. The manager can view an approval queue, which tracks requests from users that the manager must act upon, even when the requests reside on different systems.

In this embodiment, the policy enforcement feature is explained in the context of a managing entity, such as a manager, providing approval, but those experienced in the art will realize that any person or approval mechanism, including automated features, can be put in place by a company to generate the required approval.

In addition, the policy enforcement feature is explained in the context of managing booking of travel products or services. However, the present invention is not limited to this example, and can be used in other work flow management procedures. For example, an employer can use the present invention, including the policy enforcement feature, to manage employee requests for vacation time.

The present invention can read data from a system (e.g., a customer service representative (CSR) system) and incorporate automatic rules enforcement.

In an embodiment of the present invention, a request can be withdrawn by the requestor any time prior to fulfillment.

In 1505, the user makes a request using, for example, a workstation 106.

In 1510, the workflow management program 110 receives the request and determines whether this specific request requires approval (and if so by whom) or if the request meets policy guidelines.

If the request requires approval, in 1515 the workflow management program 110 routes the request to one or more managers, or alternatively one or more queues where groups of managers can approve the request. Once the request is approved, the workflow management program 110 finalizes the booking in 1520.

If the request does not require approval, in 1520 the booking is finalized. In 1525, a ticket is issued.

In an embodiment, booking is finalized by charging a credit card, acceptance of the charge by the credit card company, and issuance of the ticket.

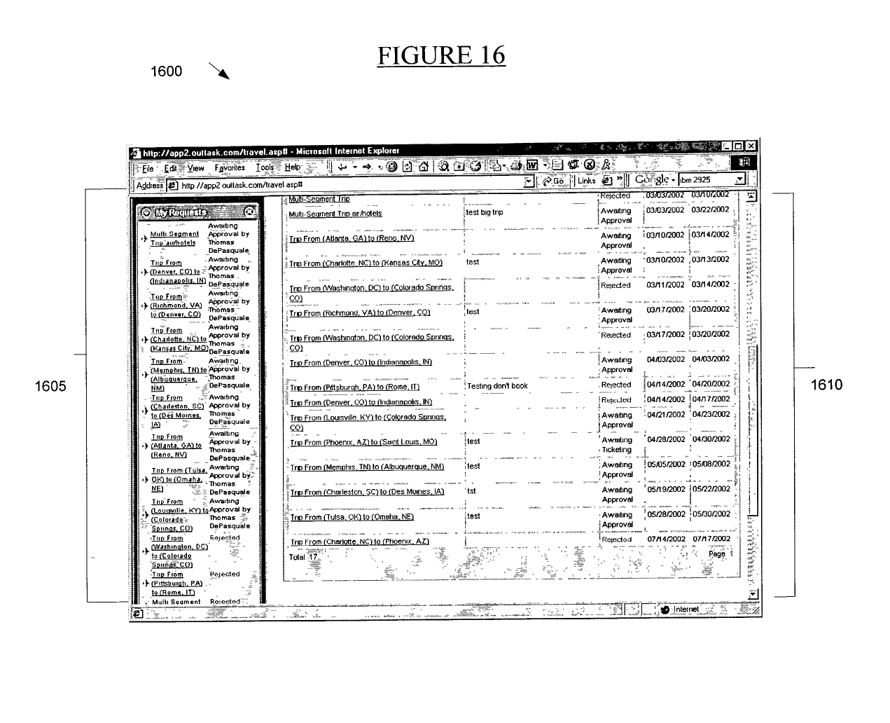

FIG. 16 is a screen 1600 illustrating a request queue, as seen by the user during process 1500 of FIG. 15 in an embodiment of the present invention. A My Requests display area 1605 allows the user to view the user's request.

In-Browser Agent Support

Referring back to FIGS. 4, 5, 7, 8, 11, and 14, the in-browser agent support feature is illustrated in an embodiment of the present invention. This embodiment of the present invention allows the user to contact an agent (e.g., a travel agent) or customer support representative (CSR) for help with online booking. This allows a user to make reservations without requiring an agent to be involved, but provides immediate availability of an agent if needed. The user can contact an agent by using a Talking Live feature 450 or a Support Center feature 445 (e.g., a shared browsing session). If the user chooses the Talking Live feature 450, the user contacts an agent for immediate support during the booking process. If the user has made a reservation, the agent is able to retrieve the reservation for review or modification while the user is online.

If the user chooses the Support Center feature 450, the user enters into an interactive chat dialog with an agent while the user is in the process of booking. The agent pushes screens to the user to assist in the booking process.

Incorporation of GDS Fares and Internet Direct Fares

Embodiments of the present invention merge both GDS fares (those accessed primarily by travel agents) and Internet direct fares into a single user interface to allow a user to comparison shop for fare selection. Fares are filtered based on travel policies input by the user. The user is notified as to the policy compliance of any fare at the time of purchase regardless of its source (e.g., GDS or Internet).

Request Prioritization

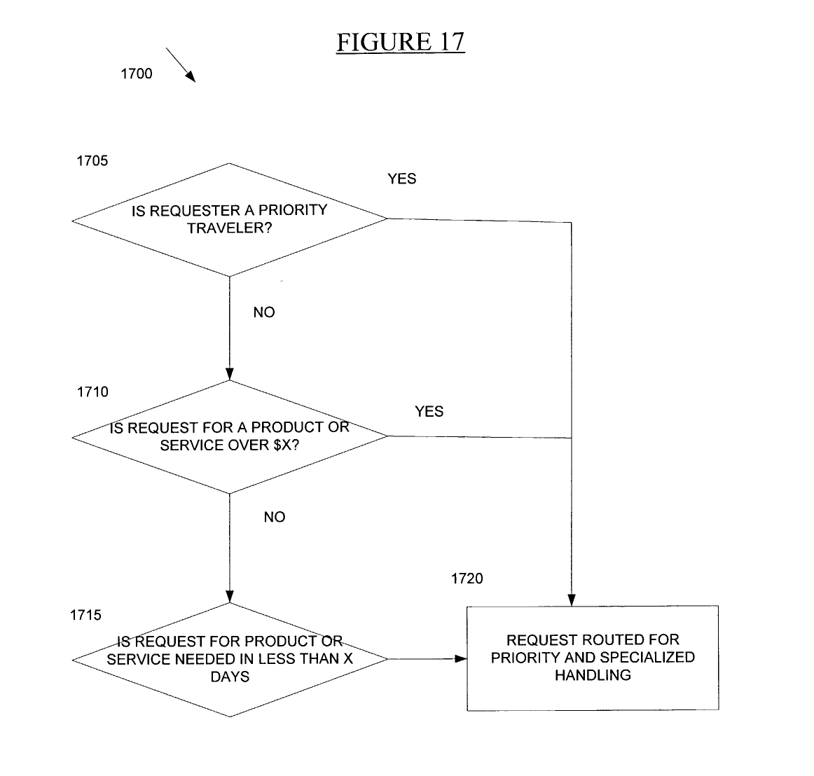

FIG. 17 is a flowchart that illustrates the prioritization feature process 1700 in an embodiment of the present invention. This feature employs configurable rules that allow agents to prioritize requests. Based on the prioritization, special attention can be paid to certain types of requests. Those experienced in the art will see that the present invention is not limited to the prioritizations discussed below for an embodiment of the present invention, and that many other prioritizations can be used in the present invention.

In 1705, the workflow management program 110 determines if the requester is defined as a priority traveler (e.g., CEO, travel manager). If yes, these travel requests are routed for priority and specialized care in 1720.

In 1710, the workflow management program 110 determines if the request is for a product or service with an expensive ticket (e.g., over $1000) that meets certain requirements (e.g., Saturday night stay). If yes, the request is routed for priority and specialized handling in 1720 (e.g., so agents can seek fee waiver requests). For example, a $2000 ticket bought 4 days before a traveler leaves, with a Saturday night stay, may qualify for a 3-week advance waiver, dropping the ticket to $800 plus a $400 fee charged by the agent. Thus, the traveler's company saves $800, and the agent makes $400.

In 1715, the workflow management program 110 determines if the request is needed in N amount of days. If yes, the request is routed for priority and specialized handling in 1720. Travelers taking trips on airlines on which they have status are routed for high priority handling for upgrades, waivers, etc. Trips can be analyzed to determine when a fare expires, and re-routed if appropriate. For example, a request for a fare good for another 10 days can go on a low priority queue. If the request is still not fully processed seven days later, the request is rerouted to a higher priority queue.

Email Confirmation and Integration

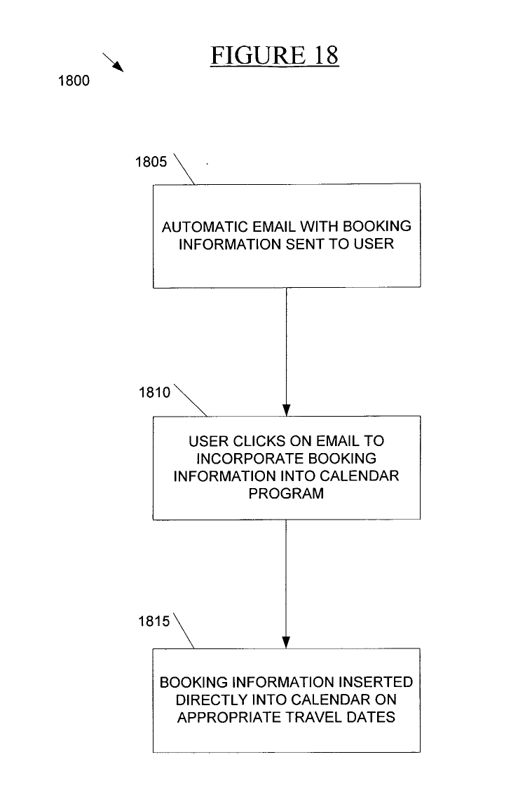

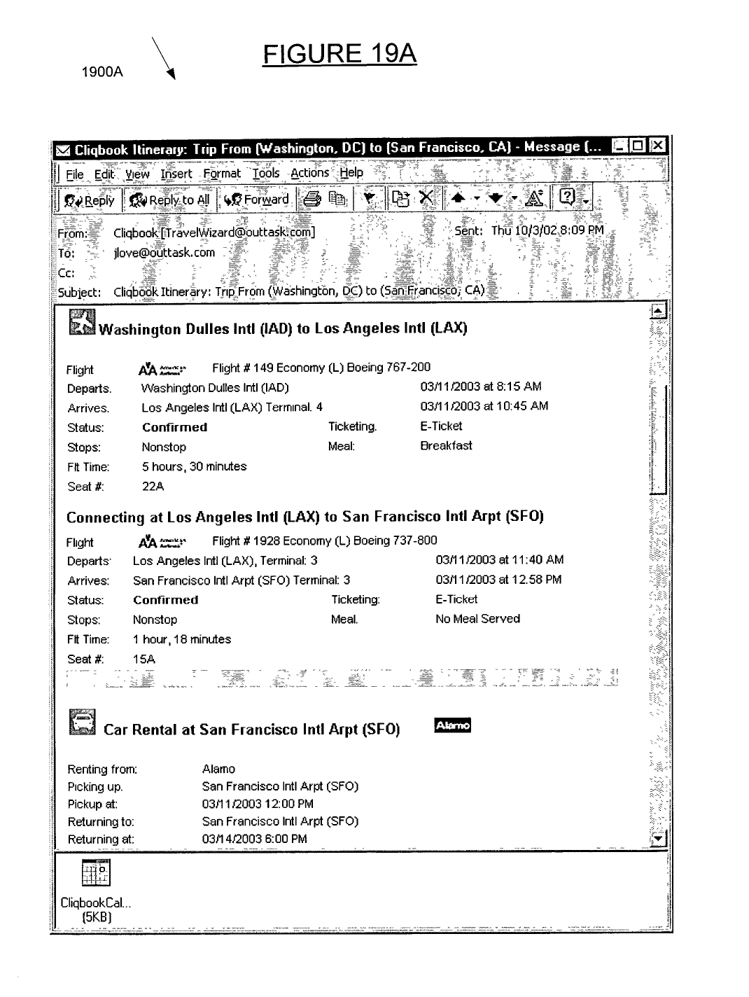

FIG. 18 is a flowchart that illustrates the email confirmation and integration feature process 1800 in an embodiment of the present invention. This feature saves the user the effort of manually entering the travel information into the calendar application, increases accuracy by automatically inserting the full itinerary into the calendar, and ensures that the traveler will have the most current electronic itinerary.

An automatic email attachment is generated when the traveler initially reserves the trip, when the agent tickets the trip, and upon any subsequent changes to the trip.

In 1805, the workflow management program 110 sends an automatically generated email, which contains information from a booking, to the user.

In 1810, upon receiving this email, the user accesses this email (e.g., by clicking on an icon in the email) to incorporate the booking information directly into their calendar program (e.g., Microsoft Outlook™ made by Microsoft Corp. of Redmond, Wash.).

In 1815, the booking information is inserted directly into the user's calendar on the appropriate travel dates. The event inserted has the full text of the itinerary. In an embodiment of the present invention, this email containing the booking information is synchronized to other personal digital assistant (PDA) devices.

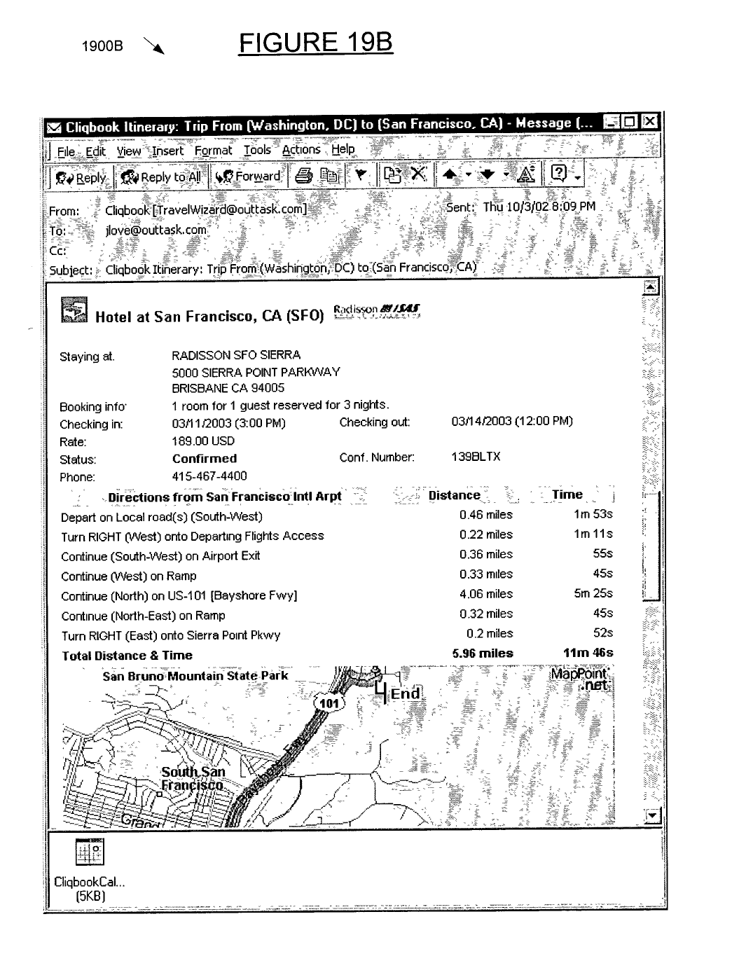

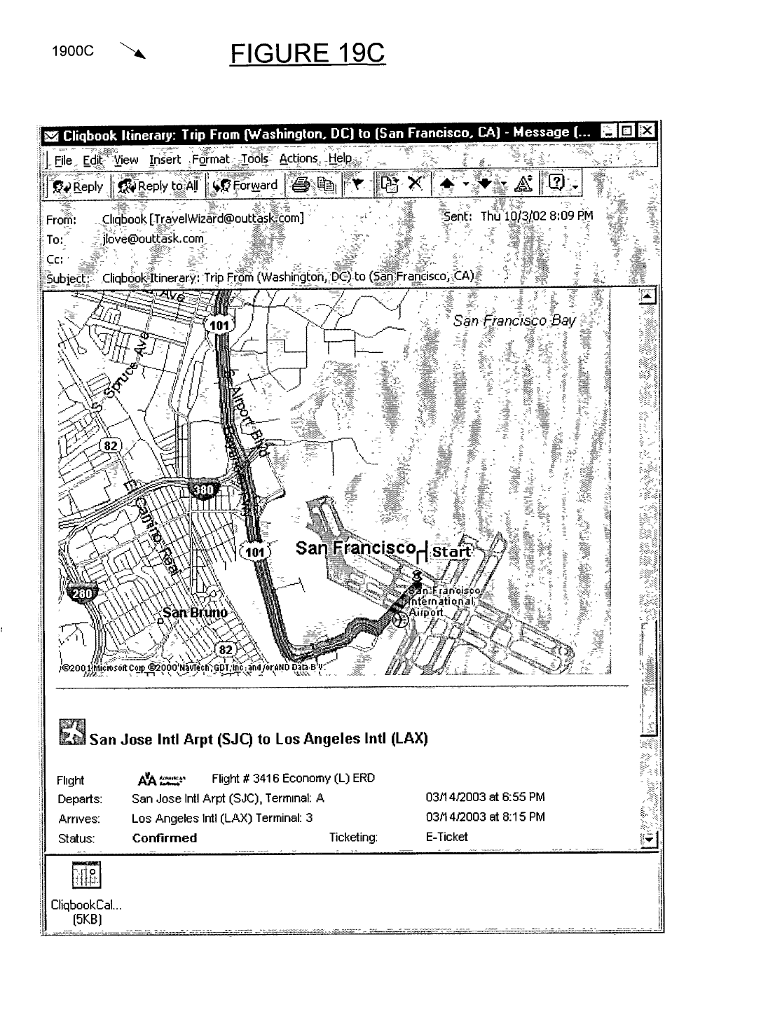

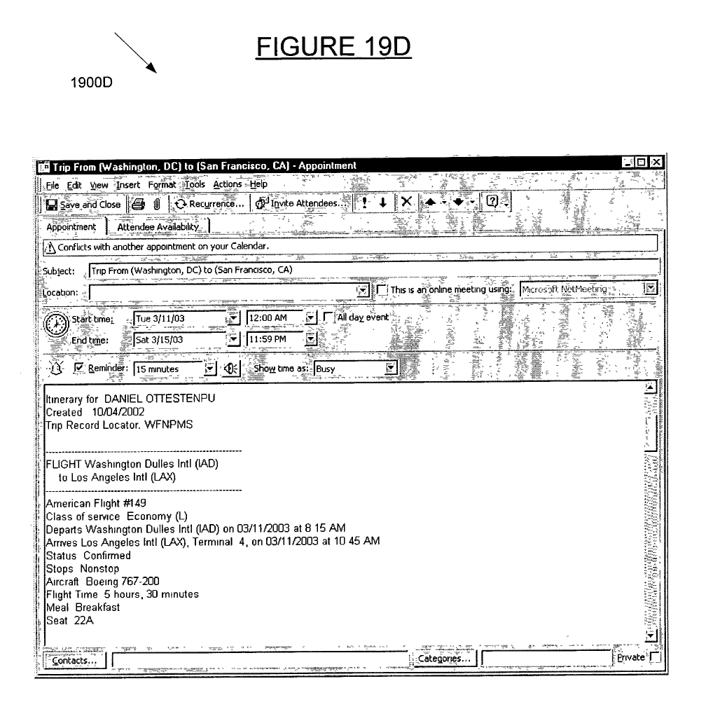

FIGS. 19A, 19B, and 19C are screen shots 1900A, 1900B, and 1900C illustrating the automatic email confirmation feature, as seen by the user during process 1800 of FIG. 18, in embodiments of the present invention. FIGS. 19D and 19E are screen shots 1900D and 1900E illustrating raw data information. The booking information from an air fare request is included in this example email.

Expense Report Data Integration

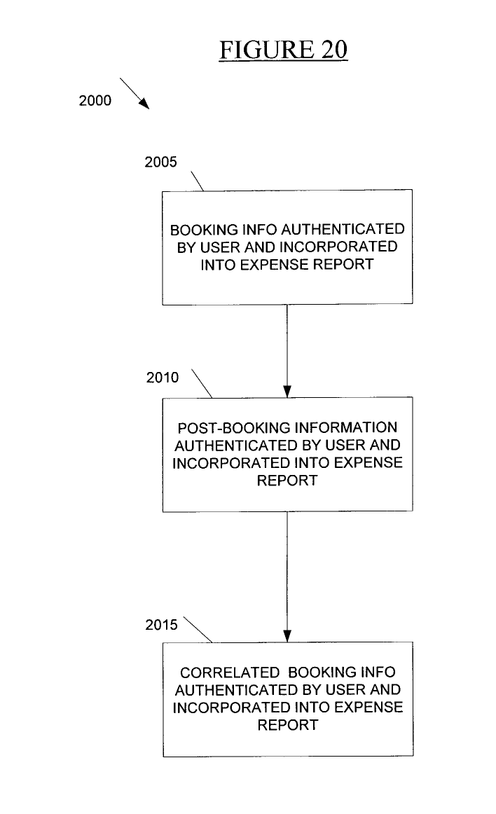

FIG. 20 is a flowchart that illustrates the expense report data integration feature 2000 in an embodiment of the present invention. In an embodiment of the present invention, multiple data source information is incorporated into an expense report. This feature allows a user to capture and track expenses electronically, freeing the user from submitting paper receipts. User authentication is made at submission time to verify the identity of the user submitting the expense. The electronic record of the expense item is maintained in an unalterable form associated with the expense. When the company needs to review the receipt, it is accessed via the workstation 106.

In 2005, booking information (e.g., credit card charge information) is authenticated by the user and incorporated into an expense report by the workflow management program 110. In an embodiment of the present invention, a user can enter an expense record from a workstation 106, a PDA, or another device. The expense is captured at the time it occurs, and then incorporated into an expense report when a user has access to a computer. Information including the following is transmitted: expense type, amount, date, project, and a comment. Once stored as an expense record, the user simply clicks the expense into the expense report. This feature is distinguished from that of filling out an expense report using a wireless device, and submitting it.

In 2010, post-booking information is authenticated by the user and incorporated into the expense report by the workflow management program 110. Post-booking information includes: travel dates, vendor, amount, departure/arrival, carrier, taxes, and record specific information (e.g., ticket number).

In 2015, correlated booking information is authenticated by the user and incorporated into the expense record by the workflow management program 110. For example, a post-booking rental car expense record will contain travel days and vendor information, but not final cost. The post-booking record is correlated with a credit card charge record to complete the rental car expense record.

Audits

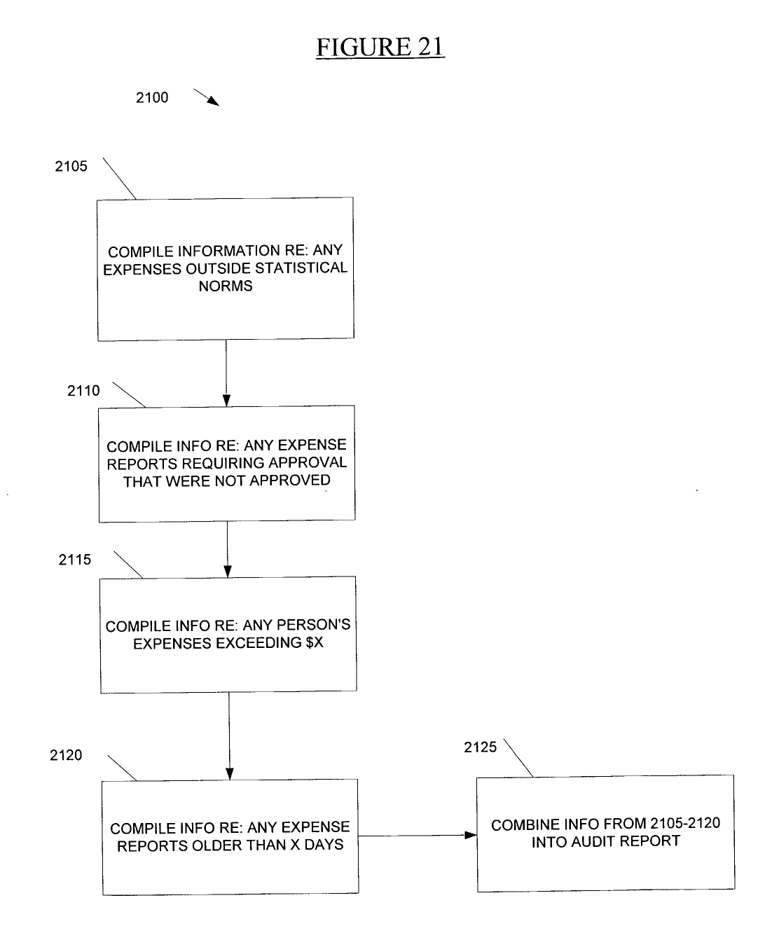

FIG. 21 is a flowchart that illustrates the audit feature process 2100 in an embodiment of the present invention. Electronic fund transfer payments are often managed for customers. The volume of the transfers is so large that there is no economical way to manually audit the transfers to see whether any defects in the system led to problems with the files. Malfunctions in the payment subsystem are costly because once the money is transferred, it is difficult to undo any errors. Additionally, there is no economical way to manually detect whether users made errors when releasing reports or if an unauthorized user had a non-valid report approved.

Those experienced in the art will see that the present invention is not limited to analyzing and compiling the information described below in an embodiment of the presentation, and that other information can be analyzed and compiled in the present invention.

In 2105, the workflow management program 110 analyzes and compiles information regarding expenses outside statistical norms.

In 2110, the workflow management program 110 analyzes and compiles information regarding individual expense reports that typically require approval to find expense reports that were not approved.

In 2115, the workflow management program 110 analyzes and compiles information regarding the total amount paid to each traveler to see if any traveler's reimbursement total is above a certain dollar threshold.

In 2120, the workflow management program 110 analyzes and compiles information regarding the age of the expense reports to see if the expense report was already paid. This prevents accidental double-payment due to system malfunction.

In 2125, the workflow management program 110 compiles information from 2105-2120, and generates audit reports. The audit reports can be generated on a daily, weekly, or other schedule basis. The audit reports are sent to the host for review, and can optionally be sent to clients (e.g., to a finance officer of a client company). The client can customize audit report parameters so that only certain audits are forwarded to the client. For example, the client can request audit reports for expense reports over $10,000. In addition the client can request the audit reports to be sent daily, weekly, or by any other time-period.

In an embodiment, the system has the ability to act on issues that are raised by the audit report, prior to sending the expense report to the client. Thus, for example, if the host reviews the audit reports, and finds that a client's employee has requested $40,000 in expenses, the host can contact the client before the client pays the $40,000.

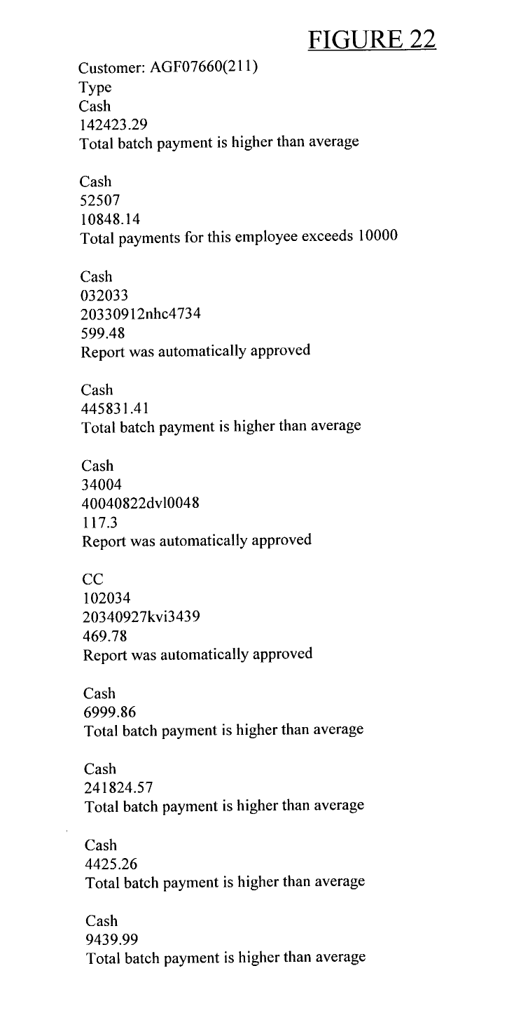

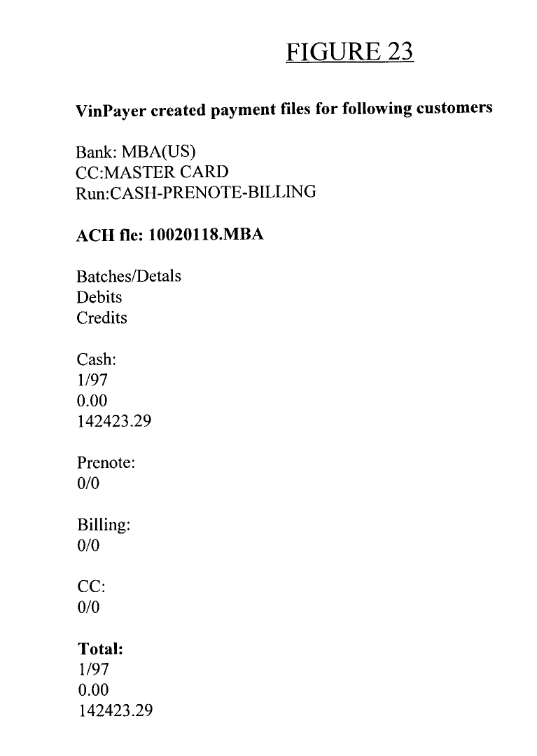

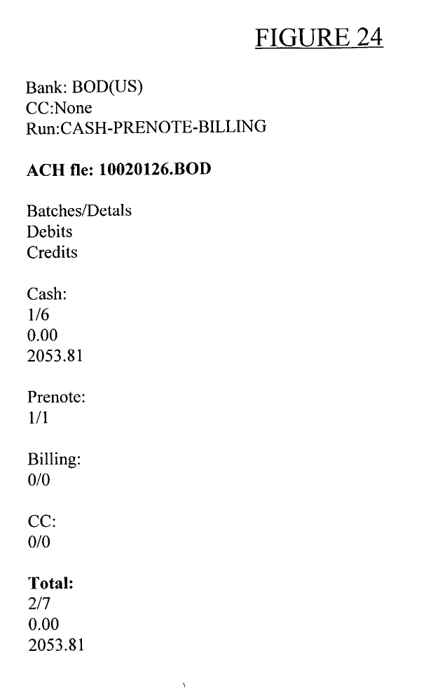

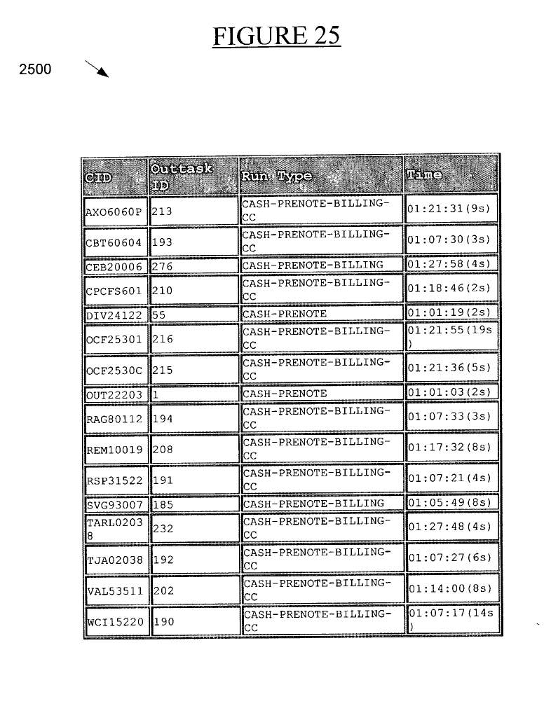

FIGS. 22-25 are screens illustrating the audit feature, as seen by the user during process 2100 of FIG. 21, in an embodiment of the present invention.

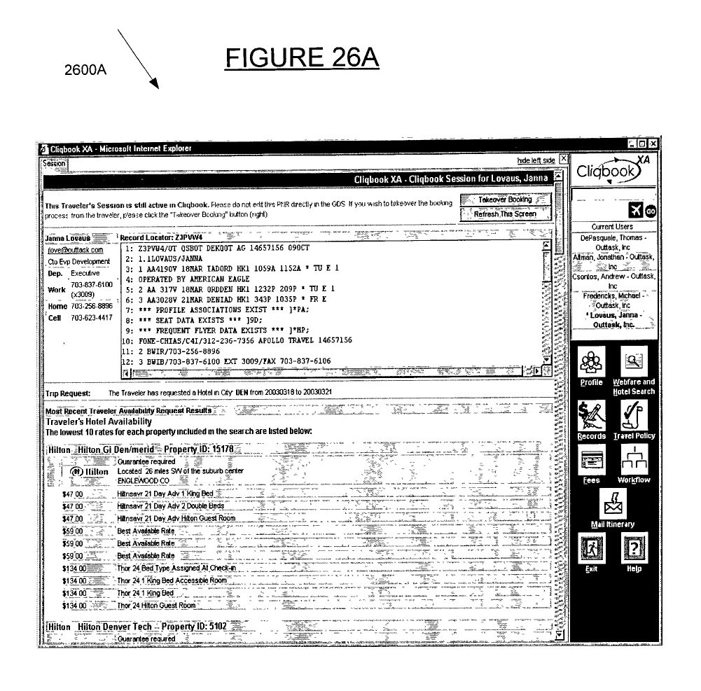

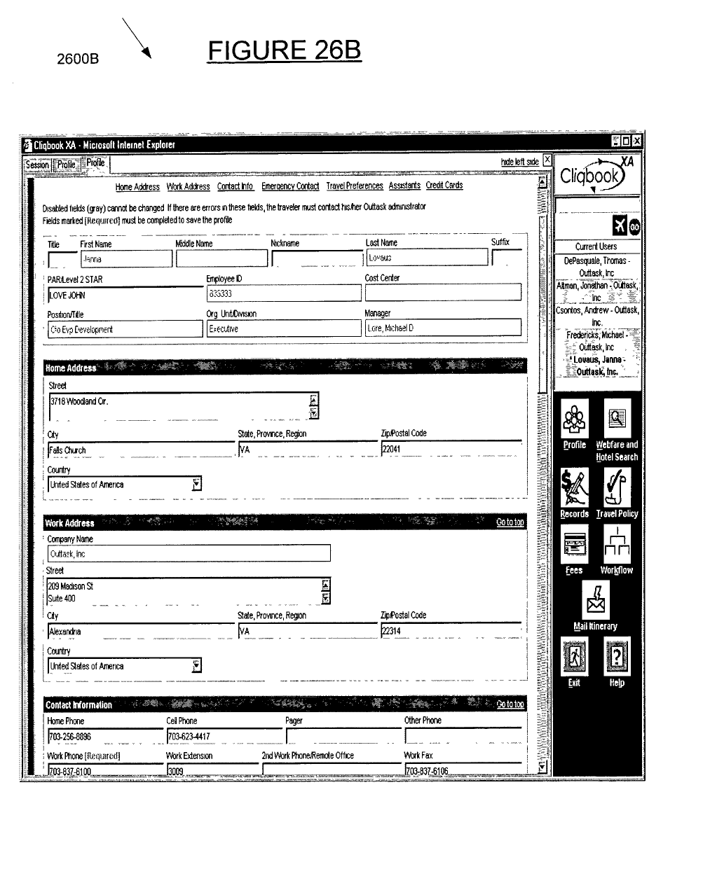

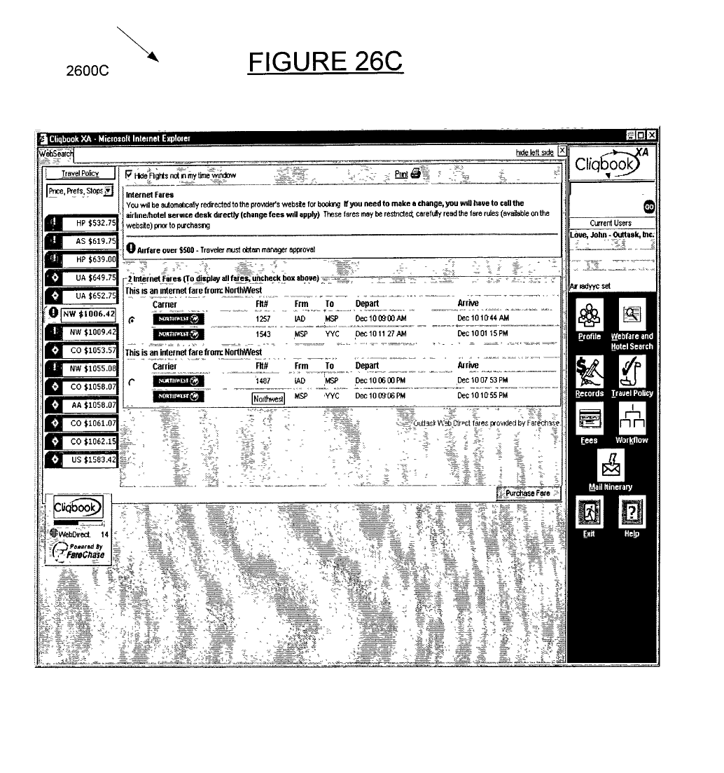

FIG. 26 illustrates an agent support tool that allows a travel agent to view the user's actions in real time, in accordance with an embodiment of the present invention. The agent support tool provides a travel agent with a set of tools to help service both online and call in customers. It provides, for example, the following features that complement the set of user capabilities in the online travel system: view contact information; view email address of any user of the system; view/edit the online profile of any user in the system; view the GDS version of the profile; view the travel policies in effect for any user in the system; view past trips that the user has taken; submit a trip into the workflow system for approval; view/modify fees charged to a user; email an updated itinerary including driving directions and maps; search the Web (and other non-GDS sources) for Air/Car/Hotel, purchase, and store back into the system the purchase—with full coding of company travel policy; and view and take over a user's progress in a concurrent online booking session.

The ability to view and take over a user's progress in a concurrent online booking session allows, the agent, while a user is in a booking session, to see exactly what the user has reserved and what air, car, or hotel inventory a customer is currently viewing. This allows an agent to assist the user in the following ways: how to use the system; advise/help in the travel planning process without having to manually do the booking (e.g., advising hotel location or quality); and actually take over the user's current booking session and complete it in their agent terminal. The agent is provided with the ability to, for example: search the Web (and other non-GDS sources) and store any purchases in the system, with full coding of company travel policy; view and edit the online profile, including the GDS version of the profile, of any user in the system; view travel policies in effect for any user in the system; view past trips that a user has taken; submit a trip into the workflow system for approval; view and modify fees charged to a user; and email an updated itinerary, including driving directions and maps.

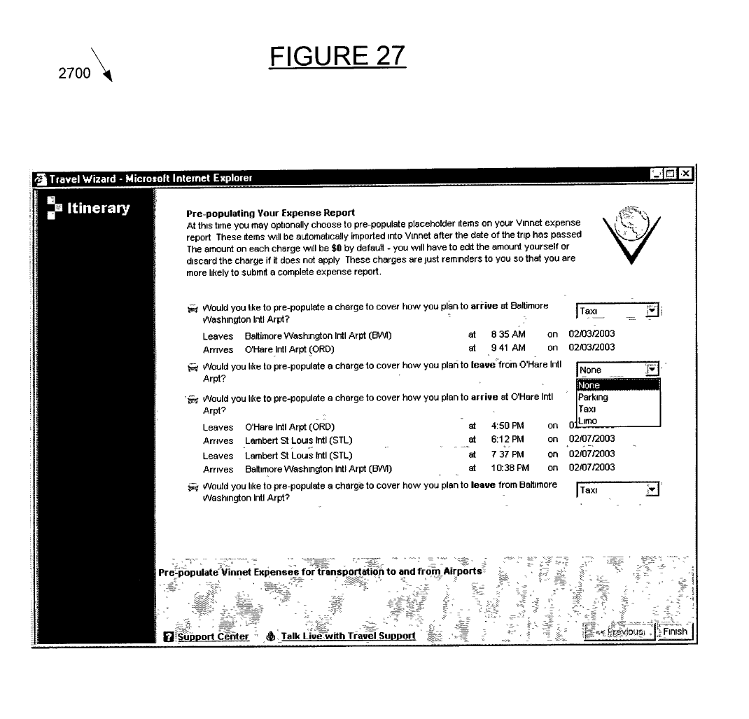

FIG. 27 illustrates a prepopulation option, in accordance with an embodiment of the present invention. This option allows the user to enter the booking information in the expense system so that a record is created of all of the travel related charges.

It should be understood that the screens, diagrams, and flowcharts shown herein, which highlight the functionality of the present invention, are presented for example purposes only. The software architecture of the present invention are sufficiently flexible and configurable such that users may navigate through the present invention in a manner other than that shown on the screens, the diagrams, and flowcharts.

While the invention has been described in terms of a few preferred embodiments, those skilled in the art will recognize that the invention can be practiced with modification within the spirit and scope of the appended claims.

What is claimed is:

1. A method for managing booking of travel products and services by a traveler, comprising:
receiving request criteria from the traveler;
retrieving at least one option that relates to the request criteria by searching multiple data sources at the same time, the multiple data sources comprising:
a global distribution system data source;
a public Web site;
a travel aggregation public Web site; and
a data source privately connected to a vendor.
displaying the at least one option to the traveler in a common interface regardless of the data source;
receiving at least one selection for booking from the at least one option; and
directing the user to one of the multiple data sources for booking of the at least one selection; and
storing booking information for the at least one selection in a record with a common interface regardless of the data source.

2. The method of claim 1, wherein the at least one option includes at least one selected from the group consisting of:
an airline ticket;
a hotel room;
a train ticket;
a limousine; and
a rental car.

3. The method of claim 1, further comprising:
booking the at least one selection by the traveler.

4. The method of claim 1, wherein the at least one option is displayed in a consistent format regardless of which data source contains at least one option.

5. The method of claim 1, wherein multiple options from multiple data sources are displayed in a consistent format.

6. The method of claim 1, wherein all outstanding requests can be viewed.

7. The method of claim 1, further comprising:
storing multiple selections in the record.

8. The method of claim 7, wherein the record is utilized to generate at least one selected from a group consisting of:
automatically generated driving directions and maps;
automatic email delivery enabling information in the one record to be stored in a calendaring program; and
automatic email notification prior to trip start including information on changes, upgrades, cancellations, and cancellation policy.

9. A method for managing booking of travel products and services, comprising:
receiving request criteria;
retrieving at least one option that relates to the request criteria by searching at least one data source;
presenting the at least one option and information on whether the at least one option is an in-policy option, compliant with a policy entered by a managing entity;
receiving at least one selection from the at least one option; and
booking the at least one selection when the at least one selection is an in-policy option.

10. The method of claim 9, further comprising:
presenting information on whether the at least one option requires approval when the at least one selection is not an in-policy option.

11. The method of claim 10, further comprising:
prompting for an explanation for the out-of-policy selection when the at least one selection is not an in-policy option; and
transmitting the explanation to the managing entity.

12. The method of claim 11, further comprising:
booking the out-of-policy selection when the at least one selection does not require approval.

13. The method of claim 11, further comprising:
determining when the managing entity approves of the out-of-policy selection when the at least one selection requires approval; and
booking the out-of-policy selection when the managing entity approves.

14. The method of claim 9, wherein the information on whether the at least one option requires approval is at least one selected from a group consisting of:
color coding; and
displaying icons.

15. The method of claim 14, wherein the color-coding comprises:
a green color coding indicating the at least one option is in-policy;
a yellow color coding indicating the at least one option is not in-policy, requires manager notification, and does not require manager approval; and
a red color coding indicating the at least one option is not in-policy, requires manager notification, and requires manager approval.

16. The method of claim 13, wherein determining when the managing entity approves of the selection further comprises:
displaying the out-of-policy selection to the managing entity in an approval queue.

17. The method of claim 13, further comprising:
displaying the out-of-policy selection to the user in a request queue.

18. A method for managing booking of travel products and services, comprising:
receiving request criteria;
retrieving at least one option that relates to the request criteria by searching at least one data source;
presenting the at least one option;
receiving at least one selection from the at least one option;
determining whether the at least one selection requires agent action;
determining whether the at least one selection is a priority request, when the at least one selection requires agent action; and
routing the priority request for priority handling when the at least one selection is a priority request.

19. The method of claim 18, wherein determining whether the at least one selection is a priority request further comprises at least one selected from the group consisting of:
determining whether the at least one selection is from a requester meeting priority traveler criteria;
determining whether the at least one selection is for a product or service meeting defined dollar criteria; and
determining whether the at least one selection is for a product or service needed in a defined time period.

20. A method for managing booking of travel products and services, comprising:
receiving request criteria;
retrieving at least one option that relates to the request criteria by searching at least one data source;
presenting the at least one option;
receiving at least one selection from the at least one option; and
providing an in-browser support feature that enables a user to contact a customer support person for booking assistance.

21. The method of claim 20, wherein the in-browser support feature comprises at least one selected from the group consisting of:
communicating with the customer support person by voice communication; and
communicating with the customer support person by communicating via a browser.

22. The method of claim 21, wherein the customer support person completes booking.

23. The method of claim 21, wherein the customer support person accesses at least one selected from a group consisting of:
traveler identification information;
current traveler selection information comprising information viewed by the user while conducting a search;
past travel history of the traveler;
automatically updated traveler profile information; and
traveler travel policy.

24. The method of claim 1, further comprising:
incorporating at least one booked selection into an expense report.

25. The method of claim 24, wherein at least one booked selection is designated as non-expensed.

26. The method of claim 24, wherein the at least one non-expensed selection is not incorporated into the expense report.

27. The method of claim 24, wherein the expense report analyzes a travel plan and comprises a list of other expenses the traveler may incur.

28. The method of claim 24, wherein information in the expense report is compared with accessible system data to ensure that it is valid.

29. The method of claim 24, wherein the information in the expense report is compared with accessible system data to determine receipt information that is already present, and receipt information that is required.

30. A method for auditing expensing of products and services, further comprising:
searching an expense report for information triggering an audit, wherein the information comprises at least one selected from a group consisting of:
information regarding expenses outside defined statistical norms;
information regarding expense reports not requiring approval when submitted by an individual that typically submits expense reports requiring approval;
information regarding expenses for an individual exceeding a defined dollar amount;
information regarding expense reports older than a defined amount of time; and
combining the information triggering an audit in an audit report.

31. A method for managing booking of travel products and services, comprising:
request criteria, wherein the request criteria comprises destination and arrival locations selected by accessing a map;
retrieving codes that correspond to the destination and arrival locations;
identifying at least one option that relates to the request criteria; and
receiving at least one selection from the at least one option.

32. The method of claim 31, wherein the codes include at least one selected from the group consisting of:
airport codes;
train station codes;
city codes; and
region codes.

33. The method of claim 32, wherein the destination and arrival locations are selected by selecting a name displayed on the map.

34. The method of claim 33, wherein the name is selected from a group consisting of:
a city; and
an airport.

35. The method of claim 32, wherein destination and arrival location selection comprises:
displaying regions on the map;
receiving a region selection from the map, wherein the region comprises at least one selected from a group consisting of:
a state;
a country;
a continent;
displaying locations within the region, wherein the locations comprise at least one selected from a group consisting of:
a city;
an airport; and
receiving a location selection.

36. A system for managing booking and expensing of products and services, comprising:
a network;
at least one terminal coupled to the network; and
at least one server coupled to the network;
wherein the at least one server comprises a program comprising:
receiving request criteria,
retrieving at least one option that relates to the request criteria by searching multiple data sources;
displaying the at least one option; and
requesting at least one selection for booking from the at least one option.

37. A system for managing booking of products and services, comprising:
means for receiving request criteria,
means for retrieving at least one option that relates to the request criteria by searching multiple data sources;
means for displaying the at least one option; and
means for requesting at least one selection for booking from the at least one option.

38. The method of claim 1, wherein a traveler's profile is constantly synchronized with the multiple data sources.
